(19) United States
(12) Patent Application Publication
(10) Pub. No.: US 2022/0179378 A1
(43) Pub. Date: Jun. 9, 2022

(54) Blockchain-Based Transactive Energy Systems

(71) Applicant: Battelle Memorial Institute, Richland, WA (US)

(72) Inventors: Sri Nikhil Gupta Gourisetti, Richland, WA (US); Steven E. Widergren, Kennewick, WA (US); Michael E. Mylrea, Alexandria, VA (US); David J. Sebastian Cardenas, Pullman, WA (US); Mark I. Borkum, Richland, WA (US); Bishnu P. Bhattarai, Kennewick, WA (US); Peng Wang, Billerica, MA (US); Alysha M. Randall, West Richland, WA (US); Hayden M. Reeve, Indianola, WA (US)

(73) Assignee: Battelle Memorial Institute, Richland, WA (US)

(21) Appl. No.: 17/537,231

(22) Filed: Nov. 29, 2021

Related U.S. Application Data
(60) Provisional application No. 63/120,818, filed on Dec. 3, 2020.

(51) Int. Cl. G05B 19/042

(52) U.S. Cl. CPC G05B 19/042; G05B 2219/2639

(57) ABSTRACT

This document describes techniques, apparatuses, and systems for a blockchain-based transactive energy system. A blockchain-based transactive energy system receives a bid associated with a supply/demand curve of a utility from a transactive node through a smart contract. A universal identifier associated with the bid may be verified by consensus nodes of the blockchain-based transactive energy system to determine a verified set of bids. The universal identifier or other data associated with the bid may be stored in an immutable database provided by a blockchain. Based on the verified set of bids, a market-clearing price of the utility may be determined and used to satisfy the bid of the transactive node according to an actual production or consumption of the utility by the transactive node. The actual production or consumption of the utility may be stored in the immutable database for future audits or verification.

### CROSS-REFERENCE TO RELATED APPLICATION/INCORPORATION BY REFERENCE

This application claims the benefit of U.S. Provisional Application No. 63/120,818, filed Dec. 3, 2020, the disclosure of which is incorporated by reference. This application also incorporates by reference the following article: Sri Nikhil Gupta Gourisetti, D. Jonathan Sebastian-Cardenas, Bishnu Bhattarai, Peng Wang, Steve Widergren, Mark Borkum, Alysha Randall, Blockchain smart contract reference framework and program logic architecture for transactive energy systems, Applied Energy, Volume 304, 2021, 117860, ISSN 0306-2619.

### STATEMENT AS TO RIGHTS TO DISCLOSURES MADE UNDER FEDERALLY-SPONSORED RESEARCH AND DEVELOPMENT

This disclosure was made with Government support under Contract DE AC0576RL01830 awarded by the U.S. Department of Energy. The Government has certain rights in the invention.

### BACKGROUND

A transactive energy system (TES) provides a market-based control and coordination mechanism for large populations of spatially distributed energy resources (DERs). A TES harnesses distributed flexibility, using economic incentives to provide various grid support functions. Recent TES progress has formed a foundation to engage and incentivize the participation of small-scale, flexible resources in various markets by defining the proper architecture, market mechanism, and TES methods. Moreover, TESs have demonstrated effective provision of grid supports ranging from power balancing to local grid congestion (e.g., voltage, thermal loading). Despite demonstrating the efficacy of TESs from the grid perspective, multiple underlying challenges remain, pertaining to privacy, security, and data integrity. Furthermore, the TES and demand response programs likely have a critical place in the future of the grid scenario because of the potential increase in clean energy and renewable energy sources. Without further development, however, current TESs are unfit to handle the security and grid complexity requirements of a utility market.

### SUMMARY

This document describes techniques, apparatuses, and systems for blockchain-based transactive energy systems. A blockchain-based TES receives a bid associated with a supply/demand curve of a utility from a transactive node through a smart contract provisioned in response to registration of the transactive node. A universal identifier associated with the bid and based on identification information associated with the transactive node may be verified by consensus nodes of the blockchain-based TES to determine a verified set of bids. The universal identifier or other data associated with the bid may be stored in an immutable database provided by a blockchain. Based on the verified set of bids, a market-clearing price of the utility may be determined and used to satisfy the bid of the transactive node according to an actual production or consumption of the utility by the transactive node. The actual production or consumption of the utility by the transactive node may be stored in the immutable database for future audits or verification. Aspects described below include blockchain-based TESs.

In aspects, blockchain-based TESs utilize an auction market to satisfy the utility requirements of producers/consumers (prosumers). For example, a bid associated with a supply/demand curve of a utility is received from a transactive node of a blockchain-based TES. The bid may be facilitated through smart contracts provisioned at registration of the transactive node by one or more consensus nodes. The smart contracts contain market logic that allows the transactive node various levels of market access to the blockchain-based TES. Based on the bid and identification information of the transactive node stored in an immutable database, a universal unique identifier associated with the bid from the transactive node may be generated, verified by the one or more consensus nodes, and stored in an immutable database provided by a blockchain. By verifying the universal unique identifier associated with the bid from the transactive node, a verified set of bids may be determined and used to determine a market-clearing price of the utility. An actual production or consumption of the utility by the transactive node may be determined and stored in the immutable database to provide verification of the blockchain-based transactive energy system at any time. Finally, the bid of the transactive node may be satisfied based on the market-clearing price of the utility and the actual production/consumption of the utility by the transactive node.

In some implementations, transactive nodes are registered by the one or more consensus nodes before a bid can be received from the transactive node. For example, the one or more consensus nodes may qualify the transactive node for participation in the blockchain-based transactive energy system. In response to qualifying the transactive node, smart contracts containing market logic that provide predetermined access to the blockchain-based transactive energy system may be provisioned to the transactive node. Additionally, the identification information of the transactive node may be stored in the immutable database.

In some implementations, the market includes one or more auctions. For example, before receiving the bid from the transactive node, a market operator node, may open an auction of the blockchain-based transactive energy system and the bid from the transactive node may be associated with the auction of the blockchain-based transactive energy system. In aspects, the opening of the auction is based on a set of logical operations configured to open the auction at a predefined time interval.

In some implementations, the market may include security checks. For example, in response to failing to verify the universal unique identifier associated with the bid from the transactive node, the determination of the market-clearing price of the utility may be delayed until the universal identifier associated with the bid from the transactive node has been verified.

In some examples, satisfying the bid of the transactive node based on the market-clearing price of the utility and the actual production or consumption of the utility by the transactive node comprises comparing the bid from the transactive node with the actual production or consumption of the utility by the transactive node and billing the transactive node based on the comparison of the bid from the transactive node to the actual production or consumption of the utility and the market-clearing price. Further, billing the transactive node may comprise retrieving the bid from the transactive node from the immutable database, comparing the bid retrieved from the immutable database with the actual production or consumption of the utility by the transactive node, and determining a consistency factor for the transactive node based on the comparison of the bid from the transactive node retrieved from the immutable database with the actual production or consumption of the utility by the transactive node. In aspects, billing the transactive node also includes verifying an integrity of the bid retrieved from the immutable database based on a signature or hash of the bid retrieved from the immutable database. In some implementations billing the transactive node further comprises incentivizing or penalizing the transactive node based on the consistency factor.

In aspects, satisfying the bid of the transactive node based on the market-clearing price of the utility and the actual production or consumption of the utility by the transactive node further comprises verification from the one or more consensus nodes of a transaction of the transactive node based on billing the transactive node. In response to verifying the transaction of the transactive node, the transaction may be stored in the immutable database.

In some implementations, the actual production or consumption of the utility by the transactive node is based on a representation of actual production or consumption of the utility by the transactive node determined by a smart meter associated with the transactive node.

In aspects, blockchain-based TESs include storing the market-clearing price in the immutable database after determining a market-clearing price. In some implementations, the one or more consensus nodes or the transactive node are associated with a producer or a consumer of the utility. In aspects, the market-clearing price is determined based on a double-auction market

In some examples, blockchain-based transactive energy systems are implemented in a system comprising at least one computer-readable storage media and at least one processor that executes instructions stored on the at least one computer-readable storage media. When executing the instructions stored on the at least one computer-readable storage media, the at least one processor may be configured to perform the blockchain-based transactive energy system described above. In aspects, the system comprises a remote server communicatively coupled to the transactive node and the one or more consensus nodes. In some implementations, the transactive node is a logical entity the meets specific criteria to participate in the blockchain-based transactive energy system

This Summary introduces simplified concepts related to blockchain-based transactive energy systems, further described in the Detailed Description and Drawings. This Summary is not intended to identify essential features of the claimed subject matter, nor is it intended for use in determining the scope of the claimed subject matter.

### BRIEF DESCRIPTION OF THE DRAWINGS

The same numbers are often used throughout the drawings to reference like features and components. The details of one or more aspects of blockchain-based transactive energy systems are described in this document with reference to the following figures:

FIG. 1 illustrates an example environment of a blockchain-based transactive energy system;

FIG. 2 illustrates an example high-level architecture of a blockchain-based transactive energy system;

FIG. 3 illustrates an example relationship diagram for node registration and qualification in a blockchain-based transactive energy system;

FIG. 4 illustrates an example relationship diagram for consumer negotiation in a blockchain-based transactive energy system;

FIG. 5 illustrates an example relationship diagram for producer negotiation in a blockchain-based transactive energy system;

FIG. 6 illustrates an example relationship diagram for measurement and verification in a blockchain-based transactive energy system;

FIG. 7 illustrates an example relationship diagram for settlement and reconciliation in a blockchain-based transactive energy system;

FIG. 8 illustrates an example implementation architecture for a blockchain-based transactive energy system;

FIG. 9-1 illustrates an example unified modeling language (UML) diagram for a blockchain-based transactive energy system;

FIG. 9-2 illustrates an example UML diagram for a blockchain-based transactive energy system;

FIG. 10 illustrates an example communication architecture of market clearance in a double-auction blockchain-based transactive energy system;

FIG. 11 illustrates an example flow chart of market clearance logic in a blockchain-based transactive energy system;

FIG. 12 illustrates an example method for node registration and qualification in a blockchain-based transactive energy system; and

FIG. 13 illustrates an example method for implementing a blockchain-based transactive energy system.

### DETAILED DESCRIPTION

### Overview

The applicability of TES to utility systems has shown the increased ability to encourage small-scale, flexible resources to participate in various utility models. However, current TES fail to meet necessary requirement pertaining to privacy, security, and data integrity. Additionally, the increased reliance on small-scale renewable resources, such as residential solar panels, requires TESs to be able to facilitate a complex marketplace to determine fair market prices and satisfaction of utility usage between various entities of differing sizes. Such an evolved future grid could involve participation from the utility-owned and non-utility-owned grid assets, hinting towards a distributed grid network as opposed to traditional, centralized systems. As described, features inherent to blockchain may be uniquely valuable when integrated into a TES to meet the necessary complexity and security requirements.

Blockchain is a distributed database that maintains a continuously growing list of public records, called blocks, which are incrementally linked together to create a digital chain. Blockchain relies on a strong set of cryptography primitives that create verifiable and immutable dependencies across blocks, thus providing traceability and protection against unauthorized revisions. In addition, each of the blocks can support computational logic (e.g., smart contracts) that can execute applications without intermediaries, thereby acting as digital transaction arbiters. Blockchain technology includes many features that can be attractive for implementing TESs, including a distributed, global, and immutable database that supports smart contracts. Specifically, blockchain-based smart contracts create an opportunity to improve the scalability and security properties of existent and future TES applications. In addition, blockchain technology can serve as a cornerstone for developing and supporting secure, decentralized grid architectures to facilitate integration of DERs, and it can provide potential solutions to emerging grid challenges.

Emerging challenges include, for example, addressing the risks associated with the Energy Internet of Things (E-IoT) and other smart grid-connected devices that follow nonsystematic approaches to integrate with the grid. In this case, risk is a complex mixture of ever-growing factors, including ubiquitous device presence, lack of cybersecurity interest (from vendors), faster-than-grid responses, and dependence on legacy technologies from an era when cybersecurity did not exist. As a result, the grid may lack the necessary defenses to prevent disruption and manipulation of DERs, grid-edge devices, and associated electrical infrastructure. Moreover, as the smart grid's dependence on communication networks increases, hidden cyber vulnerabilities will continue to pose significant threats.

In this context, blockchain technology and smart contracts present a unique opportunity to develop decentralized solutions while bolstering scalability and security. Energy delivery systems operating at the grid's edge require unprecedented levels of security and trustworthiness to verify data integrity and manage complex transactions, requirements that can be inherently satisfied through integration of blockchain technology.

Described herein is a blockchain-based, scalable, transactive market framework to address the privacy, security, and data integrity challenges within the TES. The framework provides not only an operational structure and supporting functions that may be implemented for running the transactive market but also blockchain-based architectural and system deployment insights to fulfill the distributed security integration needs of TES. Requirements for establishing a successful market have been satisfied and new desirable traits have been incorporated into the market design in the TES. Therefore, the presented framework serves as a blueprint that is designed to be modular, scalable, and broadly applicable to any distributed energy market.

Additionally, in aspects, the blockchain-based TES described illustrates the possible cybersecurity requirements of energy markets and maps them to the blockchain attributes. Such mapping not only identifies the clear value propositions of blockchain for TESs but also helps identify the blockchain attributes and components that can be leveraged for energy markets to uphold cybersecurity. It is important to note that the proposed framework is not only expected to fulfill traditional grid requirements (e.g., reliability, safety), but also to follow strong cybersecurity guidelines to support correct and continuous grid operations under most conditions.

### Example Environment

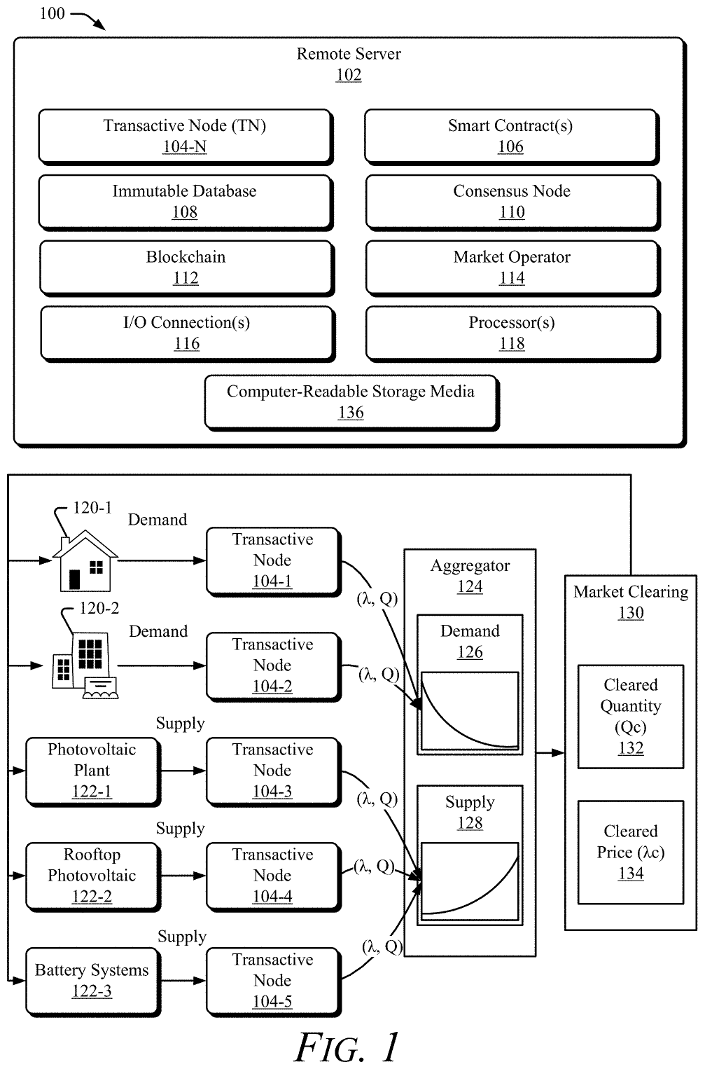

FIG. 1 illustrates an example environment 100 of a blockchain-based TES. A TES is illustrated that includes transactive nodes (TN) 104 provided to various agents in a utility market. The agents include both producers and consumers, for example, a residential consumer 120-1, a commercial utility consumer 120-2, a photovoltaic plant producer 122-1, a rooftop photovoltaic producer 122-2, and battery systems 122-3. As illustrated, transactive node 104-1 and transactive node 104-2 represent consumers, while transactive node 104-3, transactive node 104-4, and transactive node 104-5 represent producers. The consumers submit a demand bid to the market including a price (λ) and a quantity (Q) of the desired utility. Similarly, the producers submit a supply bid to the market including a price and a quantity. An aggregator 124 aggregates the supply and demand bids to determine the overall supply 128 and the overall demand 126. Once aggregated, the overall supply 128 and overall demand 126 are used in market clearing 130 where a cleared quantity 132 (Qc) and a cleared price 134 (λc) are determined and published to each of the transactive nodes 104. Though illustrated as a double-auction market, other markets are applicable and considered for the blockchain-based TES, for example, consensus and bilateral trade markets.

In the environment 100, the blockchain-based TES is implemented on a remote server 102. The remote server 102 contains computer-readable storage media 136 including machine executable instructions that are executed by at least one processor 118 to provide the blockchain-based TES. The remote server 102 may include any number of computer-readable storage media 136. The computer-readable storage media 136 may include volatile memory and non-volatile memory, which may include any suitable type, combination, or number of internal or external memory devices. Each memory of the computer-readable storage media 136 may be implemented as an on-device memory of hardware or an off-device memory that communicates data with the remote server 102 via input/output (I/O) connections 116. In one example, volatile memory includes random access memory. Alternatively, or additionally, volatile memory may include other types of memory, such as static random access memory (SRAM), synchronous dynamic random access memory (DRAM), asynchronous DRAM, double-data-rate RAM (DDR), and the like. Further, non-volatile memory may include flash memory or read-only memory (ROM). Other non-volatile memory not shown may include non-volatile RAM (NVRAM), electronically-erasable programmable ROM, embedded multimedia card (eMMC) devices, single-level cell (SLC) flash memory, multi-level cell (MLC) flash memory, and the like.

The remote server 102 contains the I/O connections 116 that communicatively couple resources and environments provided by the blockchain-based transactive energy system. The I/O connections 116 may include any combination of internal or external ports, such as USB ports, audio ports, Serial ATA (SATA) ports, PCI-express-based ports or card-slots, secure digital input/output (SDIO) slots, and/or other legacy ports. Various peripherals may be operatively coupled with I/O connection 116, such as human-input devices (HIDs), external computer-readable storage media, or other peripherals. In an aspect, the I/O connections 116 include wireless connections (e.g., Wifi, Bluetooth, Near Field Communication (NFC), and the like). The I/O connections 116 may communicatively couple the remote server 102 over any number of networks including local area network connections (LAN), wide area networks (WAN), wireless local area networks (WLAN), personal area networks (PAN), metropolitan area networks (MAN), virtual private networks (VPN), storage area networks (SAN), and the like.

The remote server 102 may include a number of environments provided to communicatively coupled devices. For example, the remote server 102 may provide a transactive node 104 (TN 104) environment for consumers or producers (prosumers) of the TES. Specific examples of prosumers or agents that may be provided the transactive node 104 environment include a residential consumer 120-1, a commercial utility consumer 120-2, a photovoltaic plant producer 122-1, a rooftop photovoltaic producer 122-2, and battery systems 122-3.

A consensus node 110 environment may be provided to voting members of the TES. Voting members may include a market operator 114, utility providers, utility consumers, or third-party verification services that vote to validate operations associated with the TES. The remote server 102 may additionally include a market operator 114 environment provided to a market operator 114 of the TES. For example, the market operator 114 may be a primary utility company that provides the TES and ensures satisfaction of the utility demands provided by the transactive node 104. In other implementations, the market operator 114 may be a consumer, producer, or an independent third party.

The remote server 102 contains a blockchain 112 that provides the inherent features of any blockchain. It should be appreciated that the framework disclosed is blockchain-agnostic and thus does not require any specific blockchain to be implemented. The blockchain 112 can be used to provide an immutable, distributed ledger (e.g., immutable database 108) to provide any time validation of the TES. The blockchain 112 may store information as blocks to provide a record of each market cycle, bid, or node/agent. Further, the blockchain 112 may rely on a strong set of cryptography primitives that create verifiable and immutable dependences across blocks, thus providing traceability and protection against unauthorized revisions. In addition, each of the blocks can support computational logic (e.g., smart contracts 106) that can execute applications without intermediaries, thereby acting as digital transaction arbiters.

In an aspect, the remote server 102 includes the immutable database 108 provided by the blockchain 112 that can store various elements during operation of the TES. Data stored in the immutable database 108 may be provisioned through the blockchain 112 as blocks comprising data for a given bid, market cycle, or node. The immutable database 108 may be local to the remote server 102 or to any environment (e.g., node) provided by the remote server 102. Alternatively, the immutable database 108 may be separate from the remote server 102 but communicatively coupled through the I/O connections 116. In some implementations, to provide scalability and reduce the data stored in the immutable database 108, data may be stored in an off-chain database and a checksum of the data stored in the off-chain database may be stored in the immutable database 108. In doing so, the data stored in the immutable database 108 may be greatly reduced.

In aspects, each of the environments provided to the transactive node 104, consensus node 110, and market operator 114 have different accessibility to the blockchain-based TES provided through smart contracts 106 integrated with the blockchain 112. The smart contracts 106 include a set of logical operations that provide accessibility to the market through predetermined market access for different environments. Specifically, the smart contracts 106 provide read/write/validate access to data within the TES. For example, a transactive node 104 may be provided with smart contracts 106 that enable the transactive node 104 to submit utility supply or demand bids to the market. The transactive node 104 environment may be provisioned differently for consumers and producers such that consumers can submit demand bids while producers may submit supply bids. Alternatively, the transactive node 104 environment may be provisioned such that a transactive node has the ability to provide supply and demand bids. The transactive node 104 may be provided read access to the immutable database 108 provided by the blockchain 112. In a TES, the access of the transactive node 104 may be limited to only see actions performed by the transactive node 104 itself. This ensures that actions or bids performed by a different transactive node 104 are not visible to the transactive node 104 in an effort to eliminate the ability of the transactive node 104 to manipulate the market in a self-benefitting fashion.

The consensus node 110 environment may include read and write access to various elements of the TES. For example, the consensus node 110 may be provisioned with smart contracts 106 that allow the consensus node 110 to validate bids made by the transactive node 104. The consensus node 110 may also be provisioned read access to the immutable database 108 provided by the blockchain 112. This may allow the consensus node 110 to verify bids, market-clearing/cycles, or nodes/agents. In some instances, a single agent may be associated with both a transactive node 104 and a consensus node 110. In these instances, the consensus node 110 and the transactive node 104 may be provisioned as a single environment provided to the agent or as separate environments.

The market operator 114 may collect and clear the bids and broadcast the clearing price 134. The market operator may have visibility to all bids made in the TES. Alternatively, the market operator 114 may have visibility to only some bids. The market operator 114 may have write access to notify the transactive node 104 of the clearing price 134 and cleared quantity 132. The market operator 114 may also have read access or write access to the immutable database 108 of the blockchain 112.

### Example Architecture

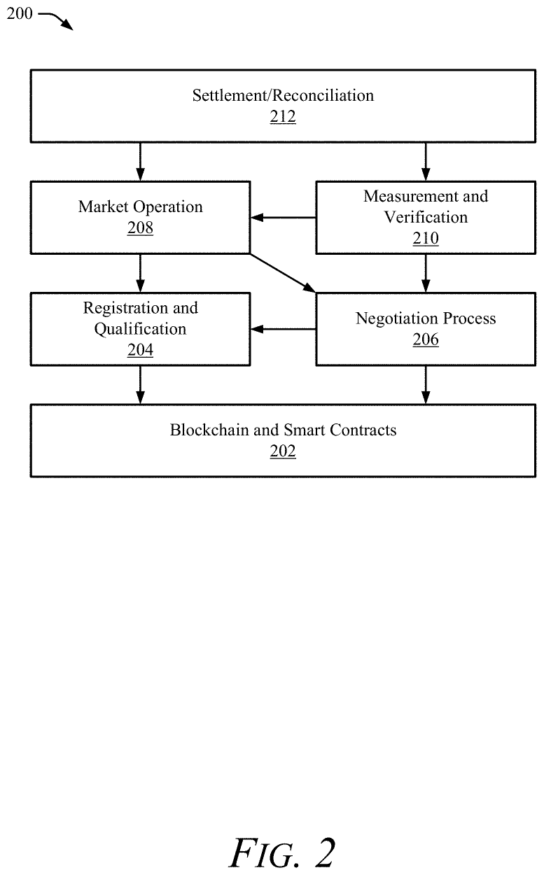

FIG. 2 illustrates an example high-level architecture 200 of a blockchain-based TES. At its core, a TES framework establishes general processes for enabling transactive energy operations. These general processes, as illustrated in the high-level architecture 200, include registration and qualification 204, negotiation process 206, market operation 208, measurement and verification 210, settlement-reconciliation 212, and blockchain and smart contracts 202.

In registration and qualification 204, a list of participants' identities and available services are registered and maintained. In the scope of a TES, the TES may be able to manage the participants' complete life cycles. This may include registering, maintaining, and eventually removing participating peers. In addition, the TES platform may provide interfaces that allow participant nodes to mutually discover and securely communicate with each other, either directly or through a coordinating agent. The responsibilities of registration and qualification 204 can be broken down into individual requirements.

For example, in registration and qualification 204, a TES may allow registered peers to access its services. A peer's operational and attestation capabilities may be qualified (vetted) before public announcement. This allows for the security and complexity requirements of the blockchain-based TES to be maintained with respect to each node. In some instances, an open, standardized protocol that allows agents to discover and reach coordinators (and vice versa) may be in effect. All communications may occur using a standardized response-reply protocol that supports nonrepudiation, which is secured during transit. In addition, transported/stored messages may use a standardized container/encoding. This ensures that data received by and from nodes can be handled analogously and independent of the specific node and that an intermediary is not needed to process data. Messages may have a validation process, including validating the identity, access permissions, and container structure. Adequate role-based and identity-based access permissions to each of the underlying services of the TES may be defined in advance. Policies may be based on the least-privilege principle and include fail-safe defaults. Permissions may be defined for all participating entities, including overseers (e.g., distributed system operators (DSOs), market forecasters, etc.). Mechanisms that ensure a globally unique state may be present (e.g., consensus safety), and thus, allow peers, coordinators, and supporting infrastructure to act based on a global system state. Unreachable peers may be identified and removed to increase system liveness. Data and communication privacy may be paramount. Specifically, because markets are competitive, peers may have strong privacy guarantees (e.g., protecting their bids and capabilities from disclosure). A distributed, immutable, global-state database that records bids, contracts, and data objects, as well as prior settlements among peers, may be maintained. This distributed database may serve as the data repository for most services/applications.

Blockchain and smart contracts 202 are employed to provide inherent capability to meet the requirements detailed above. Specifically, blockchain and smart contracts 202 provide a cryptographic reliance to ensure data security, which helps satisfy the security requirements of the TES. Blockchain and smart contracts 202 can be used to provision logic to nodes that contain operations to facilitate predetermined access into the market. Because the smart contracts are provisioned by the TES, it can be ensured that the operations performed using the smart contracts are in specific form and therefore, can be handled without an intermediary. Moreover, blockchain and smart contracts 202 can be used to provide an immutable database to maintain peers/nodes, bids, and data objects associated with the TES.

These native features not only satisfy the requirements laid out in the previous sections, but also introduce extra capabilities, such as the ability to deploy program logic (e.g., smart contracts) that can reside within the infrastructure. This may provide the advantage of limiting the reliance on external software to integrate a diverse set of tools/technologies that potentially introduce interoperability issues. In fact, these features create new opportunities such as enabling logic-driven consensus algorithms, empowering access controls, and enabling contract auditing at the edge. These blockchain/smart contract (BCSC) features can be graphically observed, which exemplifies how modularization and subsequent encapsulation can be used to leverage individual functions and properties of the BCSC to fulfill the technical requirements of a TES.

Another portion of the TES is the negotiation process 206, which is responsible for establishing the rules of the negotiation process. Once the communication mechanisms have been established and peer participation has been enabled, the next step is to establish the rules of the negotiation process 206. Ideally, this process may aim for transparency, with well-defined goals and subject to safety and operational limits. The negotiation process 206 focuses on collecting the future needs (demands) and matching them to available supply resources, thus facilitating market clearing. Like registration and qualification 204, the negotiation process 206 can be broken down into a set of requirements.

For example, the negotiation process 206 may support transactions occurring between transactive agents and a system coordinator (e.g., through a bid system) or between transactive agents (e.g., a bilateral negotiation). This may be implemented through blockchain and smart contracts 202 by provisioning smart contracts that contain peer-to-peer logic to allow transactive nodes to communicate with one another or peer-to-utility logic to allow transactive nodes and the market operator to communicate. Mechanisms for securely storing received bids and offers and for eventually disseminating the final clearing terms may be in place. To respect privacy, dissemination may involve only relevant parties. Similarly, this may be implemented through smart contracts that publish data only to relevant nodes during market operation. The negotiation process 206 may be bounded by market-defined time constraints that depend on the trading horizon. Efficient and reliable communication protocols may be in place, along with a time-efficient bid/clearing process. This can be facilitated through combination of the registration and qualification 204 process and the blockchain and smart contracts 202. For example, registration and qualification 204 can ensure that all participating nodes meet the qualifications to keep the TES running smoothly and efficiently, while smart contracts can control the logical operations that are performed as part of market clearing and operation. Negotiators (e.g., transactive nodes, the market operator) exchange non-repudiable bid/request messages that are compliant with the market rules and underlying grid infrastructure. Lastly, in the negotiation process 206, the bids/requests may contain the originator ID, prices, demand curves, time limits, cost functions, and any other required properties in a standardized, contract-like message object. After transactive agents reach a market decision via a rule-based consensus, cleared prices and accepted bids may be stored for accountability and auditing purposes. In addition, mechanisms that uphold adequate privacy policies may be implemented (e.g., to maintain competitiveness). Blockchain and smart contracts 202 can ensure the logic used to exchange bids and messages, while providing an immutable database for recordation, thus satisfying the above requirements.

Market operation 208 dictates the bidding and contract obligation rules (market clearing). In this phase, actual energy transactions occur, and consumption and generation may be as close as possible to the market-cleared quantities. In some cases, measurements might be estimated or approximated to maintain the system balance. The responsibilities of market operation 208 can be broken down into requirements.

Specifically, transactive nodes are expected to operate according to market decisions. Peers may attempt to follow prescheduled demand/production curves. Deviations, along with justifications (if available) may be recorded, tracked, and traced to impose applicable penalties. Agents in the field (which include measurement devices) are expected to report their local observations (e.g., power quantities). In some instances, certain peers might be able to report values for other peers that go offline or fail to report their values, depending on the system observability. Market coordinators may be able to monitor the energy imbalances, detect unfulfilled contracts, and adjust the reserved capacity as needed, for example, direct energy from storage reserves or other markets.

After market operation 208, measurement and verification 210 verifies and validates the actual TES exchanges. Agents may behave according to the market-clearing rules, resulting in unmalicious power imbalances. This is not always the case however, therefore, auditing mechanisms may be built into the platform. At a basic level, this can be achieved by constantly comparing an agent's reported values against trusted energy measurements. Yet, before such a verification process can proceed, the system may adopt a chain-of-trust mechanism that provides a legal precedent. This may include securing the measurements at the source, using trusted communication networks, and employing secure storage mechanisms. Storage mechanisms can be leveraged to support advanced data analytics if historical records are maintained. Therefore, the market agent may perform tasks such as consistency evaluation and better predicting market behavior (e.g., improve forecasts). Requirements that may exist in such an environment are discussed below.

In some implementations, each participant's operational records may be stored within a trusted, coherent state database, for example, the immutable database provided by a blockchain, to support real-time and post-event audits. The system coordinator may monitor the communications occurring at each of the dependent peers through pre-determined access provisioned in smart contracts. Agents may have to agree to record values at system-defined intervals or as requested by the coordinator according to specifications at registration and qualification 204. In doing so, the chain of trust may begin at the acquisition stage.

External grid devices, as well as qualified peers, may provide remote attestation capabilities by measuring power-related variables. Therefore, a chain of trust may be validated throughout execution of the TES. The coordinator may, at any time, require peers to report their instantaneous values and potentially request a remote attestation for auditing purposes. Information mismatches may trigger non-compliance warnings or lead to peer removal. The actions of the transactive agents with respect to their negotiated commitment may be validated, and deviations may be recorded. Market unbalances or inconsistency issues may be traced back to their source. Inherent uncertainties in the market forecasting model may be distinguishable from artificially induced mismatches, including unfulfilled contracts and other market-participant-induced behaviors. Blockchain is particularly useful to satisfy these requirements due to the immutable nature of the ledger. Further, smart contracts can be provisioned to distinguish deviations and facilitate the removal of nodes from the TES.

In settlement/reconciliation 212, arbitration and reconciliation/settlement processes may be enforced. Market settlement is done by comparing the market-cleared quantities to the actual consumption and production values and assigning monetary values. In some instances, this occurs after the predefined market interval has elapsed. This interval may be dependent on the available markets (which can be stacked) and can range from a few minutes to entire days. This means there may be instances in which settlements can only occur hours or days after the actual event. Therefore, market settlement may be based on recorded energy exchanges (which are assumed to be correct) and their deviations from the cleared market. Depending on the deviation type, adjustments with respect to the cleared price can result in peers paying a mixture of spot prices and penalization costs based on the previously agreed-upon contracts/commitments. For any spot market, settlement may be done on the basis of cleared quantity and actually consumed quantity. The settlement for market interval T may be done at T+ΔT (where ΔT is the market interval) as follows:

If Qₐ=Q_{c} then λ_{c}×Qₐ

If Qₐ<Q_{c} then λ_{c}×Q_{c}

If Qₐ>Q_{c} then λ_{c}×Qₐ

where Q, Qc, and Qa are bid quantity, quantity cleared from the market, and actually consumed/produced quantity, respectively. In some instances, the quantity cleared from the market is different for each node and based on the bid quantity for that node. In general, when the actual consumption matches the cleared quantity, no penalty is imposed on the market participants, and the market participants will pay (or be paid) for the actual quantity consumed at the market-cleared price (e.g., λc×Qa). However, if the actual consumption is larger or smaller than the cleared quantity, the market participants may incur a penalty. If the consumption is larger than the cleared quantity, additional generation may be required, and the market participants may pay based on the cost of the additional supply resource brought in. For example, the market participant may pay based on a predetermined cost for supplemental energy generation. Specifically, if the actual consumption is larger or smaller than the cleared quantity the difference may be charged at the cost of the additional supply resource brought in or based on the cost to store the additional resource supplied.

Settlement/reconciliation 212 may be broken down into the following requirements. The resources to verify and enforce the legally binding contracts may be provided. Stipulations may be established during the negotiation phase according to market-cleared quantities/prices. Contract verification may occur by comparing recorded values to the market-cleared quantities, as shown above. The platform may provide mechanisms to compute and assess contract deviations using market-defined terms and conditions, which can be reconfigured as needed subject to consensus. The specifics of the cost function may be agreed to in the negotiation phase. Billing may be updated at the end of the market cycle (e.g., once all measurements have been collected) and may be traceable and confidential. Multiple bills may be aggregated in order to produce more traditional period-defined bills (e.g., monthly). Based on the high-level architecture 200 and the described responsibilities of each process, the blockchain-based TES can be broken down into a set of handshakes between the various nodes and resources.

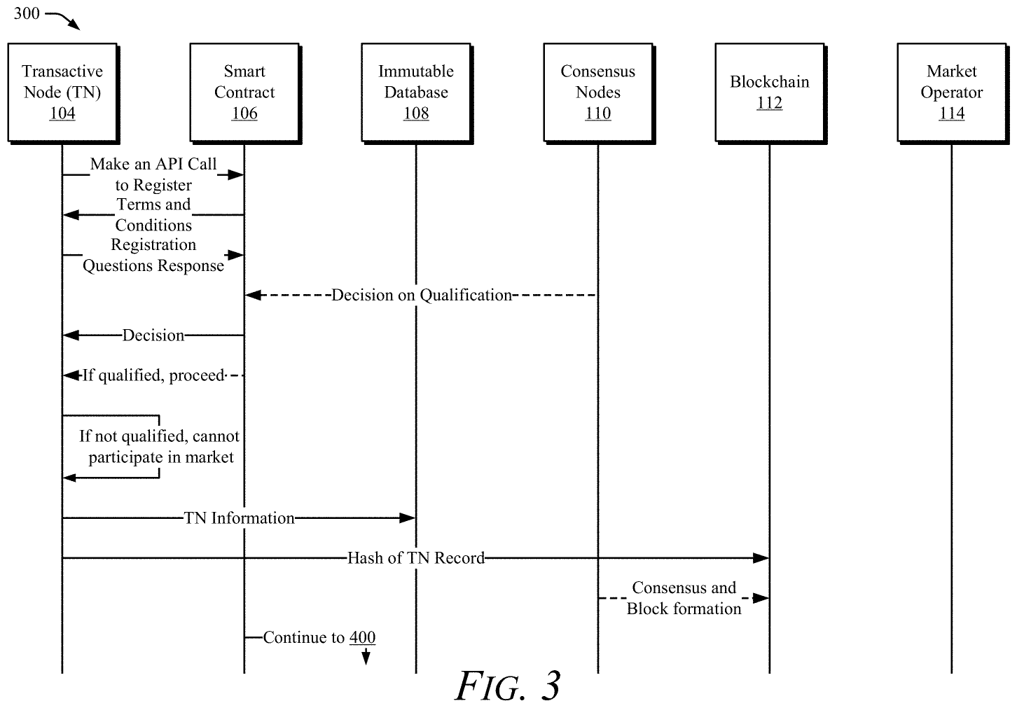

FIG. 3 illustrates an example relationship diagram 300 for node registration and qualification in a blockchain-based TES. Participants may be forced to register before access to the TES is granted. In aspects, the registration process can be initialized by a human or an automated agent by contacting the registration service. For example, registration may be initiated through a secure, standardized, open specification application programming interface (API) that defines the message structure, available functions, and return codes that can register an agent as a transactive node 104 or another node. In response, terms and conditions may be received by the agent defining specific criteria the transactive node 104 must meet to participate in the blockchain-based transactive energy system. In some instances, the automated agent is a logical entity that must meet certain software requirements or security/encryption requirements to participate in the TES.

The process itself may include responding to the qualification questionnaire to determine services and capabilities of the agent. The qualification/approval process can be implemented by using smart contract 106 logic or a central server to determine whether announced services/capabilities conform to the requirements or by using a group of predetermined consensus nodes 110 that decide whether the registrant is qualified. In some instances, qualification may be decided by consensus nodes 110 based on the qualification questionnaire or other information associated with the agent. If a consensus-based approach is used, the voting scheme can be configured in such a way that results are based on a simple majority, approval from all organizations, a certain acceptance/rejection ratio, or a combination of schemes based on fault-tolerance and speed/performance requirements. An advantage of using fault-tolerant consensus is the ability to reduce single points of failure and still maintain privacy. If approval is granted, life-cycle management may be started for the transactive node 104 and an environment may be provisioned to the agent. Peer life-cycle management may be performed by storing and protecting registration information and any future transaction information in a global, immutable ledger (e.g., immutable database 108) provided by the blockchain 112. If approval is not granted, however, the agent may be restricted from participation in the market.

In addition, the peer's permissions may be established based on its identity, role requirements, and available service qualifications. In general, the transactive node 104 may be given write access, utilities and DSOs may have read and write access, while market and supervisory applications may be given read access. Once the life-cycle management has begun, the system may issue a set of credentials and identities that are returned to the incoming peer (aka the transactive node information). These credentials, along with the system-level access permissions, may drive most of the privacy-preserving mechanisms. In addition, credentials (e.g., based on Public Key Infrastructure (PKI), blockchain 112, and smart contracts 106 mechanisms) satisfy the peer-side nonrepudiation requirements. In addition to the initial registration process, a background maintenance task may identify inactive nodes and performs audits across the life cycle.

In some implementations, the transactive node 104 information is stored as a hash within the immutable database 108. Additionally, information from the consensus nodes 110 regarding the qualification of the transactive node may be included during block formation. As such, the market operator 114 may not be needed to provide registration and qualification. In other implementations, the market operator 114 may set the requirements for qualification or the terms and conditions. Moreover, the market operator 114 may be included in the consensus nodes 110 and vote on registration and qualification.

In some instances, an agent is registered or qualified as a consensus node 110. To qualify as a consensus node 110, additional qualifications may be required. In general, however, the process flow may be similar to that which is detailed above for node registration and qualification no matter the environment. In response to registration, an appropriate environment may be provided to the agent.

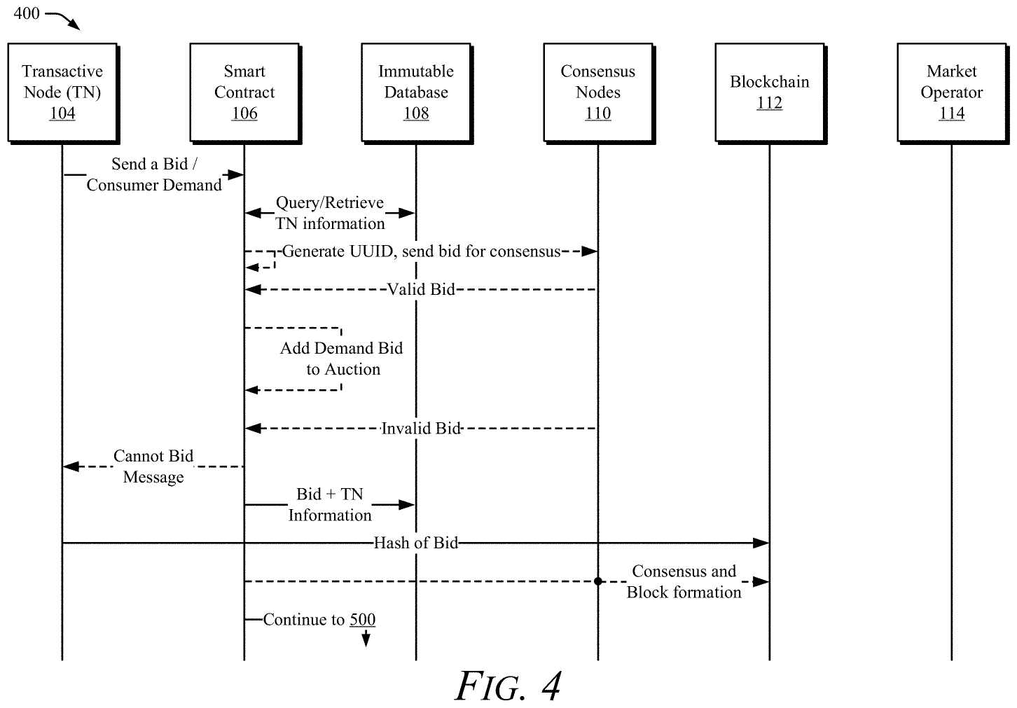

FIG. 4 illustrates an example relationship diagram 400 for consumer negotiation in a blockchain-based TES. In some implementations, the negotiation process is based on the double-auction implementation. Negotiations may be intended to occur between an individual transactive node 104 and the market. It should be noted, however, that though illustrated as a double auction market, the negotiation process may incorporate both the peer-to-peer and peer-to-utility models. The negotiation process may leverage the mechanisms provisioned in the registration and qualification process. For example, environments provisioned to the nodes (e.g., transactive node 104 and consensus nodes 110) in the registration and qualification process can be used to facilitate the negotiation process. In aspects, the smart contracts 106 include logical operations that allow the nodes access to the market, The smart contracts 106 may be provisioned to implement the market logic required for the negotiation process, for example, as a double auction market.

However, because blockchain technology is public, modifications to ensure the security and privacy of an agent during the negotiation process may be employed. In one example, a rotational, universally unique identifier (R-UUID) is used as the agent ID. Using a pseudo-random algorithm, a unique identifier may be generated for each agent at each market cycle, which prevents other agents from analyzing patterns and gaining insider knowledge. Although R-UUID appears random, the DSO, utility, and other authorized entities can perform a mapping operation to resolve the agent's identity. Therefore, the privacy of the agent's identity can be maintained with respect to peers, while necessary market monitors may determine the agent's identity. In some implementations, the R-UUID may be mapped using PKI.

In the relationship diagram 400, the market is defined to operate using a consensus-based, double-auction mechanism. The transactive node 104 sends a bid associated with a supply curve of the utility or a demand curve of the utility. In aspects, the supply curve or demand curve may be a single quantity and price associated with a utility or a set of processes and quantities associated with the utility. In general, a transactive node 104 registered as a supplier provides a supply curve, while a transactive node 104 registered as a consumer provides a demand curve. In the relationship diagram 400, the transactive node 104 submits a demand bid. In response, the immutable database 108 is queried using the smart contract 106 to determine information associated with the transactive node 104. In aspects, this information can be used to verify the transactive node or generate the R-UUID.

Although the bidding history of the transactive node 104 may remain private for the market to be fair, identities are may still be needed to maintain traceability and enforce contracts. To manage this issue, interested agents may request an R-UUID (which is only valid for a market cycle) from the TES coordinator. For example, the smart contract 106 may facilitate the request for the R-UUID and return an R-UUID. The returned R-UUID may be used to mask the identity of the transactive node 104 (privacy preservation) and thereby prevent market manipulation attacks. Transactive nodes may, as desired, issue bids using the DSO-defined, smart contract 106 submission interface. In some implementations, this includes the system-provided R-UUID token, a creation timestamp, and a bidding offer/request according to the predefined format. The issued bids may then be signed (preventing repudiation) and submitted for validation. In some implementations, the bids are signed using PKI.

Using the access control mechanisms, certain identity-dependent write operations are permitted via smart contracts 106. For example, the transactive node 104 may only bid on its own behalf, a market operator 114 or utility may start and end a market cycle, and market simulators and forecast simulators may write demand predictions. Again, by reusing the existing access control mechanisms, identity-dependent views are generated from the blockchain 112. For example, the transactive node 104 may access their own, complete profile, a market operator 114 or utility may see the agent capabilities/qualifications along with the bids, and market simulators and forecast simulators may see R-UUIDs and their bids (but not their capabilities). In some implementations, third-party peers may be allowed read access to the market and access may be provided to only observations of bid submissions without identity headers.

The received bid, or R-UUID, may be checked by the consensus nodes 110 for validity. Based on the validity of the received bid, and contingent on access permissions, accepted bids or the consensus information may be recorded in the immutable database 108. If a bid is invalid, the transactive node 104 or other peers may be notified that the bid is invalid or otherwise failed. Depending on the time and the number of available resources, in-depth validations may occur; this might involve analyzing the individual's reliability metrics or validating the bid/peer provenance using the smart contracts 106. The system-defined smart contract 106 may use its internal logic to consolidate all valid supply and demand bids according to the double-auction rules. The smart contract 106 may either be executed in a single server or use the consensus nodes 110 infrastructure to approve/validate bids.

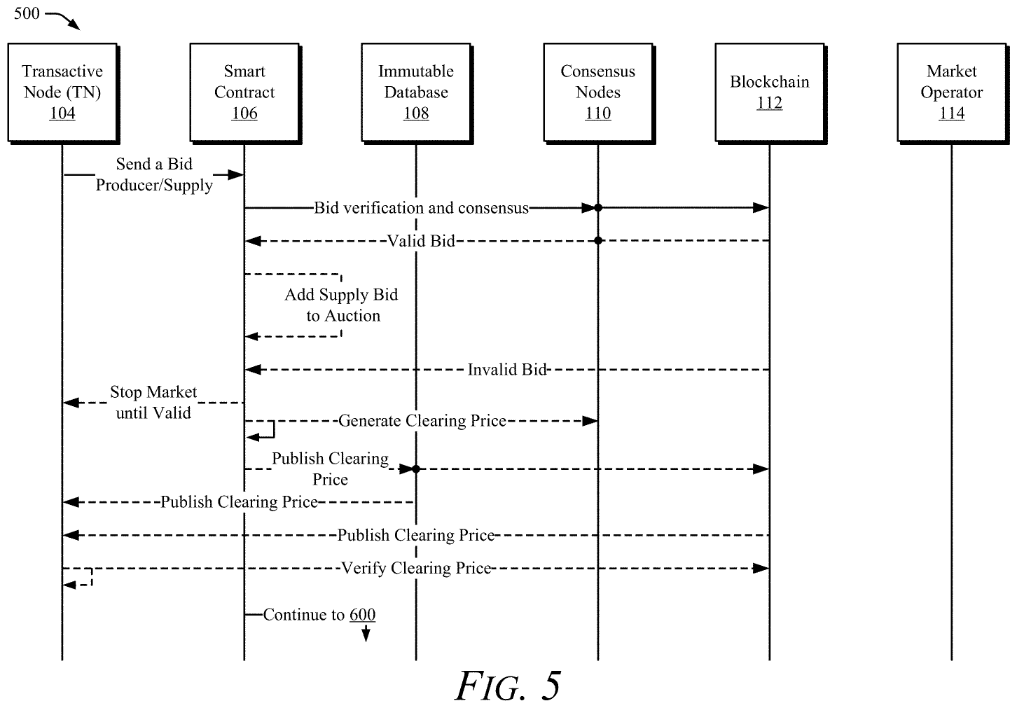

FIG. 5 illustrates an example relationship diagram 500 for producer negotiation in a blockchain-based TES. In general, the relationship diagram 500 is similar to the consumer negotiation illustrated in FIG. 4. In the relationship diagram 500, however, the transactive node 104 is a supply bid associated with a supply curve of the utility. The bid may be facilitated through the smart contract 106 and verified by the consensus nodes 110. Again, this verification can be done in various ways, such as those described in FIG. 4, based on time and complexity constraints. The verified bid may be stored in the immutable database 108. The bid may again be verified or stored as an R-UUID to preserve the identity of the transactive node 104. In some instances, invalid bids may cause a pause in execution of the market until the bid is verified or removed. In other implementations, an invalid bid may be communicated to the transactive node or other peers through a message.

Once verified, the bid may be added to the market and a clearing price may be determined through the smart contract 106. Once the market has cleared, the clearing price may be published by the blockchain 112 to the immutable database 108 with visibility to the transactive node 104. In some implementations, all participating nodes will have access to the published data. To store data using blockchain 112, a block is created and appended to the immutable database 108. Within the blockchain 112 environment, block creation may be achieved by either, storing all bids within a time-defined interval inside a block (e.g., per market cycle). In aspects, the published clearing price can be verified by the transactive node 104 by referencing the immutable database 108.

After the negotiation process detailed in FIGS. 4 and 5, the market operation may be performed. The operation process is fully related to a physical exchange of the utility (e.g., buying and selling). Therefore, an intermediary mechanism may be used to record the physical transactions and adequately encode them into the underlying database or ledger. In some instances, these mechanisms will reuse the existing measuring infrastructure and adapt it, as needed, to suit the new requirements. Such improvements may increase the agent's visibility, improve reporting rates and global-timing requirements, and also upgrade the cybersecurity aspects to match the blockchain or TES expectations.

After a market decision has been made, all involved parties may behave according to the accepted bids and other applicable market rules. In aspects, agents will agree via terms and conditions to a legal obligation to report accurate, time-stamped values either in real time or afterward, using approved consolidation methods. To implement a chain of trust, the TES may be able to receive metering data that has been adequately acquired, processed, and vetted. To handle both live-data feeds and intermittent sources, a mechanism may be used to organize the reported values according to the timestamp.

The received data, which may include the internal and external power values along with operational directives, may be regularly stored inside the immutable database 108 to support later stages (e.g., the verification and settlement process). This process may occur during the market operation or might be integrated into measurement and verification. The TES may exchange its power imbalance data with other local balancing authorities (or other grid operators) as needed. These mechanisms can be further expanded to support real-time power imbalance markets or other applications. Once market operation has concluded, measurement and verification may be performed.

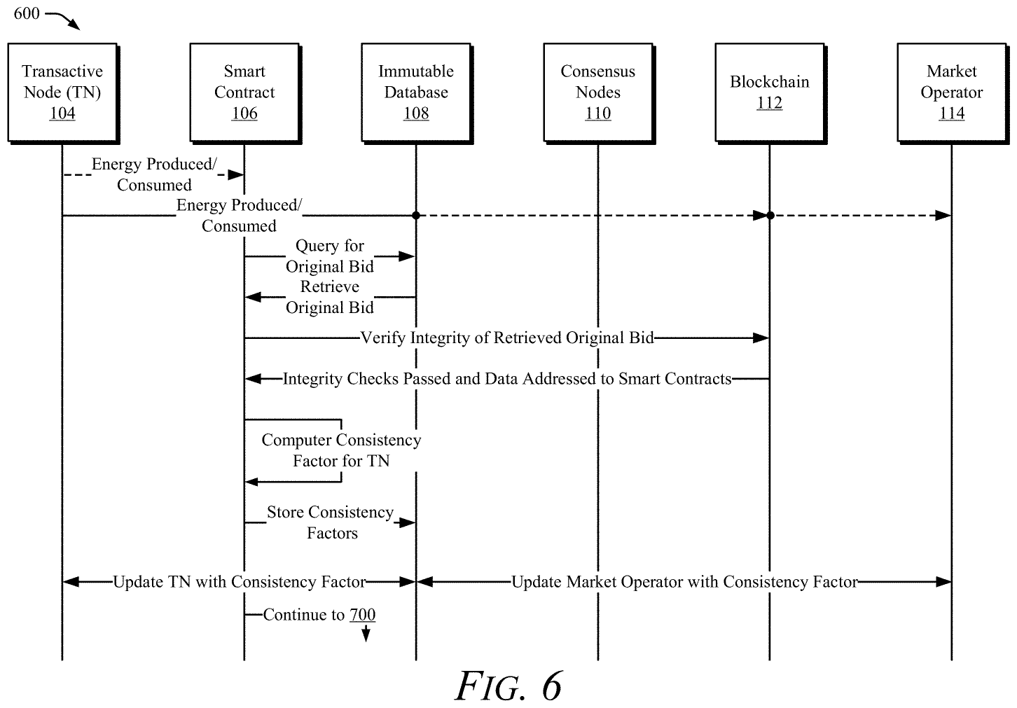

FIG. 6 illustrates an example relationship diagram 600 for measurement and verification in a blockchain-based TES. As described above, one of the core strengths of blockchain technology is its immutable data recording process that facilitates verifiability. Therefore, measurement and verification may be modeled around the immutability and provenience properties of the blockchain 112 either directly or indirectly. Indirect dependencies can arise when data are processed by other modules or when abstractions occur (e.g., service encapsulation). To provide full trust in a blockchain-stored record, however, certain well-defined procedures may be sustained across a record's life cycle. In some cases, this includes implementing the measures for adequate access permissions to grant access to the global, immutable database 108 and strong adherence to the blockchain 112 creation processes. It may also include verifying data provenance (e.g., signature validity, identity, time stamps, system consensus, R-UUID usage) and data structure/conformance before operating on the record's contents (e.g., assigning trust).

An example of the developed measurement and verification process is illustrated in FIG. 6. All validations may be considered valid if the blind trust requirements are met. Since the blockchain platform is agnostic to the type of participating nodes, a variety of nodes can be used to store data and measurements. In some examples, the data and measurements may be provided by sensors, computer systems, or humans. The market operator 114 can receive/request data from peers at any time. For example, automatic reporting can occur during the operation phase by request or at a prudent time after the market cycle ends. Mechanisms can be used to strengthen measurement and verification, such as timestamps and a cumulative chain of trust. The market operator 114 may have backward visibility of all communications, transactions, and data records that are associated with participating nodes. This may include having the ability to review bid processes, operational records, and historical data stored in the immutable database 108.

The actions and behaviors of the transactive node 104 with respect to the negotiated commitments (e.g., bids) may be validated at the end of a market cycle or at DSO-defined intervals. Post-cycle market validations may rely heavily on retrieving bidding, measurement, and operational records from the immutable database 108 and evaluating them for compliance. Discrepancies found may then be stored in the immutable database 108 for use in future processing. The collected records may be aggregated over time to evaluate the consistency and reliability of an agent's commitment in light of their actual behavior and later be used to improve market performance (e.g., better forecasts and adequate reserve sizing). For example, the smart contract 106 may compare the actual volume of the utility consumed or produced by the transactive node 104 and the original bid placed by the transactive node 104. Based on the comparison, a consistency factor may be computed for the transactive node 104 and stored within the immutable database 108. The consistency factor may be communicated to the market operator 114 or the transactive node 104. Moreover, the discrepancies or the consistency factors may be used in settlement and reconciliation for billing the transactive node 104.

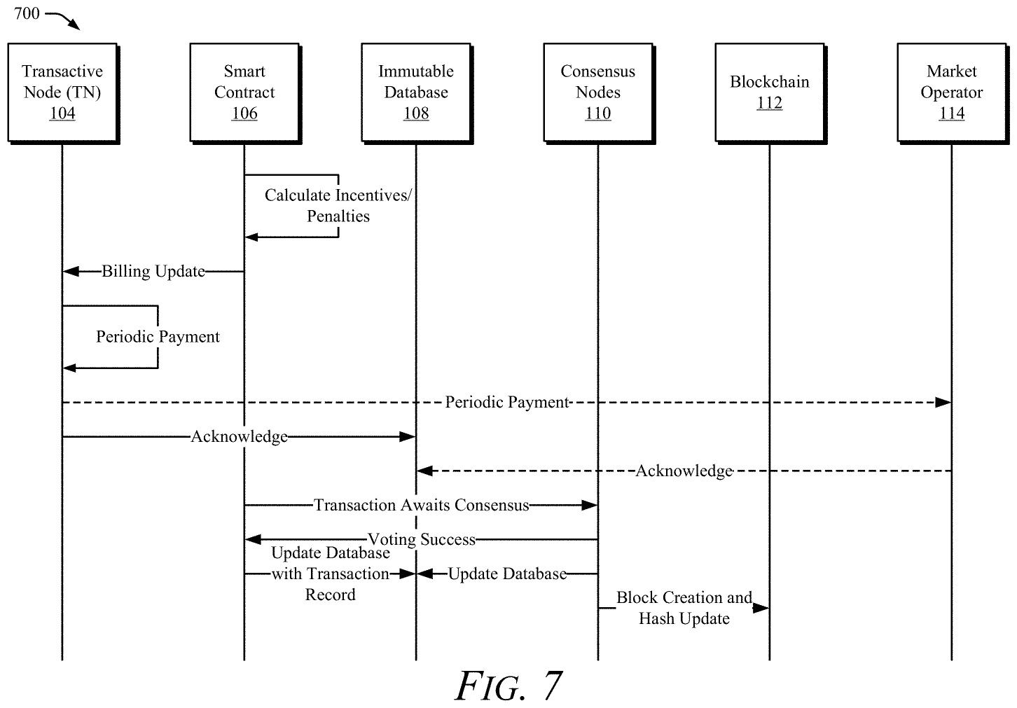

FIG. 7 illustrates an example relationship diagram 700 for settlement and reconciliation in a blockchain-based TES. The final stage of a TES market cycle is the settlement process. At this stage, the previously identified discrepancies may be converted to a transaction (e.g., billing) based on the market-clearing price, grid participation fees (if any), and the cost of unfulfilled obligations. In this particular application, the deviation records may be used to determine incentives and penalties that impact the finalized transaction. In the general sense, the transactive node 104 will be penalized if the node produces less than the original bid value or consumes more than the original bid value

Settlement may occur at the end of a market cycle, or as soon as the data become available. In aspects, peers have agreed to the specifics of the settlement process during the bid submission process, for example, through terms and conditions or original bidding. Deviations of actual consumption/production values from approved bids may be input to a cost function to calculate incentives/penalties. The function terms and structure may be globally defined by the smart contract 106, but specific coefficients may be applied to each transactive node 104 or market cycle based on previously agreed-upon terms and conditions. A bill may be updated based on the incentives/penalties and delivered to the interested party, for example, the transactive node 104. In some implementations, bills may not be provided every market cycle and thus, allow the billing to fit normal market practices (e.g., monthly billing). In these instances, bills may be aggregated until the billing interval, at which point they are provided to the transactive node 104 for payment. Although bills are considered private information, multiple bills can be consolidated at area level or feeder level to satisfy regulations. In addition, the consensus nodes 110 may be used to routinely enter billing and payment information into the ledger. This may allow transaction rules to be published and visible to all peers in the market.

Once a bill has been received, a payment can be made. A payment may be made peer-to-peer or peer-to-utility either autonomously or physically. For example, a payment may be made directly between a consumer transactive node 104 and a producer transactive node 104. Alternatively, payment may be made from a consumer transactive node 104 to the market operator 114. The market operator 114 may then distribute payment to the producer transactive node 104. Even in peer-to-peer implementations, however, payment information may be sent to the market operator 114. Payment may be transmitted without mediation, for example, through automatic withdrawal or transfer. Alternatively, physical payment may be required. The transactive node 104 or the market operator 114 may acknowledge payment of a bill through the blockchain 112. For example, by storing acknowledgment in the immutable database 108. In this manner, records of received payments can also be stored inside the immutable database 108.

In following the processes detailed, a consensus-based TES can be created that guarantees that data and market operations are correct. Additionally, the smart contract 106 framework can be implemented with any consensus-based platform making the TES model applicable to a number of preexisting markets. The immutable database 108 may provide scalable and auditable storage that is inherently usable by the smart contracts 106. Additionally, protections may be provided that utilize PKI to ensure that access is provided only to trusted entities.

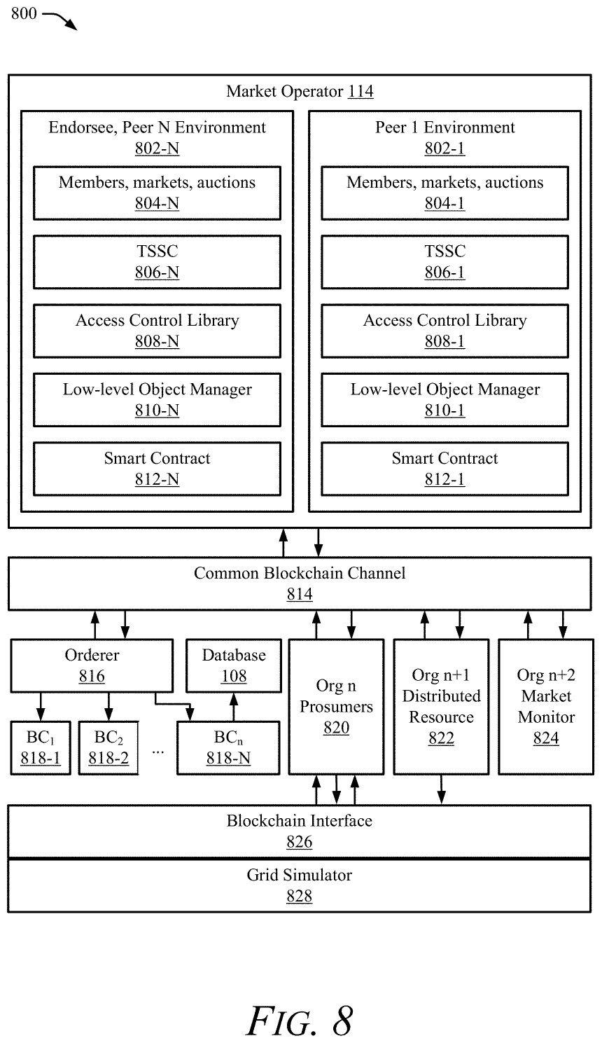

FIG. 8 illustrates an example implementation architecture 800 for a blockchain-based TES. As detailed above, the described blockchain-based TES is agnostic to a specific blockchain. Thus, selection of the underlying blockchain platform may depend on the end user's application needs, such as privacy, timing, and operational cost requirements. For TES applications, permissioned blockchains implementations (e.g., based on proof of authority or voting-based consensus), such as those provided by Hyperledger Fabric, Hyperledger Sawtooth, and Quorum (among others), may be used to satisfy the requirements of a TES deployment. Specifically, Hyperledger Fabric offers a fully open-source stack with no operational costs other than those related to initial deployment and associated energy costs of operating a networked set of computer devices acting as peers. Furthermore, the wide community support and continuously evolving features of Hyperledger Fabric make it a viable candidate with the potential to support certain long-term requirements of grid applications. In addition, peers can independently be set up and audited by organizations that want to participate in the crash fault-tolerant consensus algorithm (e.g., endorsing peers). This may include (but is not limited to) utilities/DSOs, independent market monitors, market participants, and transmission operators. However, for the participants to be part of the consensus process, they may have to first be registered by the membership service provider. Therefore, certain authority or prior approval may be possessed to allow the formation of the consensus nodes.

### Example Implementations

Using the high-architecture presented in FIG. 2, a smart-contract application was developed based on the Hyperledger Fabric blockchain platform. The application, as illustrated, is programmed in JavaScript and is executed on top of the Fabric 2.2 environment using the chaincode interface (e.g., implemented in blockchain interface 826). The chaincode interface negotiates interactions with the blockchain. The application uses the same modularization techniques that were described in FIGS. 3-7. It begins by reusing the security primitives provided by the blockchain interface 826. For example, providing a signed request with an embedded user credential transmitted over common blockchain channel 814 and an immutable database 108.

The second level bridges the application storage requirements with the orderer 816. The orderer 816 controls the formation of blocks (e.g., block 818-1, block 818-2, and block 818-N) and storage into the immutable database 108. On top of this, an access control library 808 (e.g., access control library 808-1, access control library 808-N), may be used to support the least-privilege access controls principle. Specifically, pre-determined access control may be provisioned with peer environment 802 by the market operator 114 as access control libraries 808 based on environment type. For example, the Peer 1 Environment 802-1 may represent a transactive node (e.g., prosumers 820) and the access control library 808-1 may provide access to the immutable database 108 and to bids placed by the transactive node itself. In contrast, Peer N Environment 802-N may represent a market monitor 824 and the access control library 808-N may provide access to all bids submitted in the market. For a specific environment, the access control library 808 can be any number of pre-determined accesses as discussed above. The prosumers 820 submit bids through the blockchain interface 826. The distributed resource 822, for example, the utility, has access through the common blockchain channel 814 and the blockchain interface 826. The market monitor 824 may be visible to all bids through the common blockchain channel 814.

Finally, the application logic executes at the top level. The top level uses a mixture of security descriptors, class definitions, and application-level logic to reply to any request that comes through the common blockchain channel 814. This may include member, market, and auction 804 information, a low-level object manager 810, or smart contracts 812. Smart contracts are provisioned as logical operations accessible to the peers. The low-level object manager 810 handles data communicated to the peer environment 802 through the common blockchain channel 814. The common blockchain channel 814, in this case, represents both the network link and the blockchain interface 826 and allows peers to process, endorse, submit, and commit to a transaction.

In addition, a grid simulation tool 828 (e.g., via OpenDSS, an electric power distribution system simulator) may be integrated into the testbed. In this case, OpenDSS was interfaced via OpenDSSDirect.py along with custom Python wrappers to produce web-based bid requests that are received and processed by the Technical Standards Subcommittee (TSSC 806) network (via JavaScript Object Notation remote procedure calls). The integrated platform allows researchers to evaluate the performance of the market in the presence of a grid model.

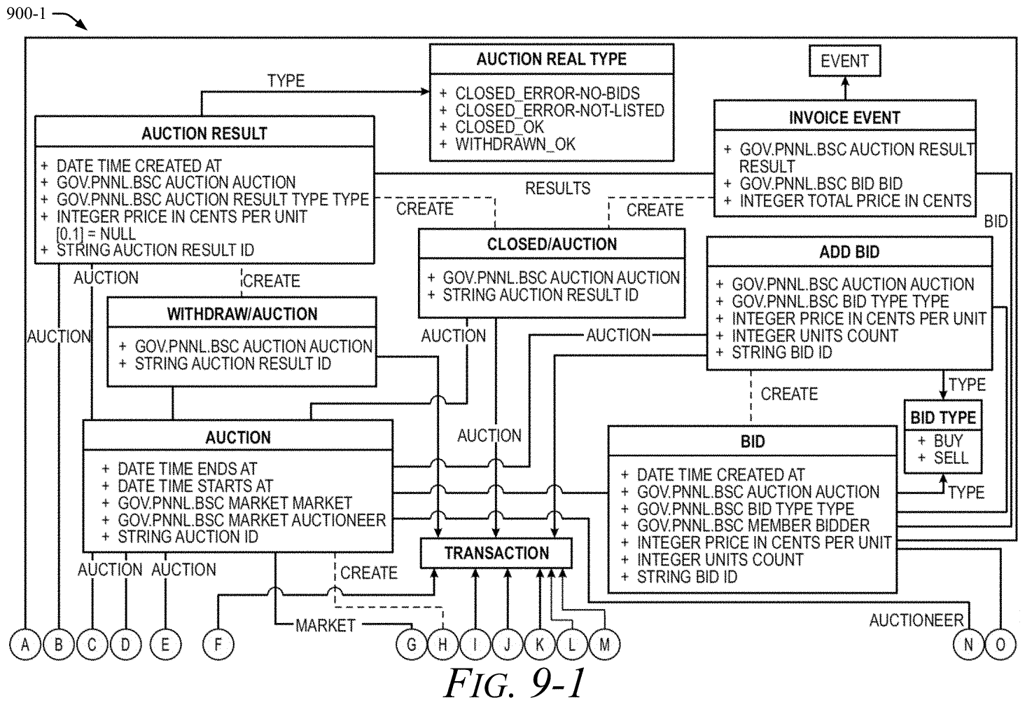

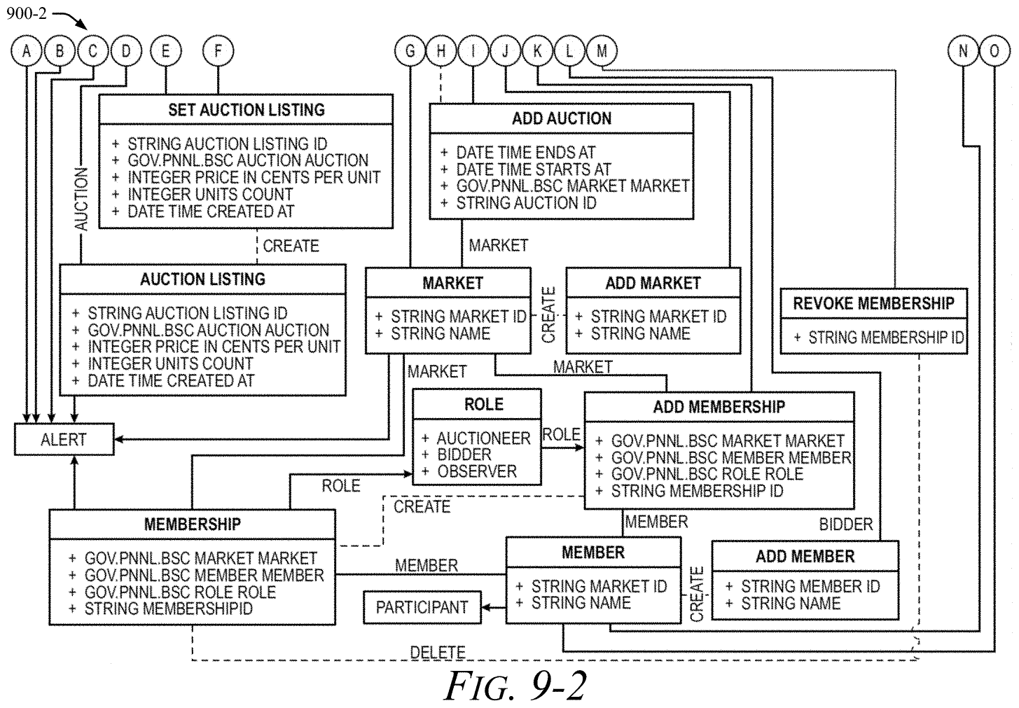

FIGS. 9-1 and 9-2 illustrate an example unified modeling language (UML) diagram for a blockchain-based TES. Execution may begin once a valid function invocation is received. In addition, the functions may implement the necessary logic to prevent unauthorized users from invoking them. Illustrated in the UML diagram of FIGS. 9-1 and 9-2, the TES may be broken down into the following functions. An addMember function may add a member to the world state. For example, this may include providing the highest-level API to an agent to allow node registration and qualification. A member ID or a name may be provisioned as a string to add the member as a participant in the TES. An addMarket function may be supported that defines a new market in which auctions can take place. The addMarket function may include provisioning a market ID and name as strings to create a market with the provisioned credentials. To assign a role to the members with respect to the market, and addMembership function may be supported that assigns market-specific roles to members. To this effect, membership may be specific to a market, member, or role and be represented by a membership ID. In aspects, roles may include market operators, consensus nodes, transactive nodes, or any other market participant. In some implementations, the roles are segmented into three categories: auctioneer, bidder, and observer. Auctioneers hold auctions where bidders may place bids as supply bids or demand bids to the auction. Observers oversee the market or auction, for example, as consensus nodes or market monitors. In some instances, membership may be revoked due to failure to abide by market rules or for a lack of consistency in bids and actual volume of a utility. In such instances, a revokeMembership function may revoke the membership of a member by removing the membership ID from the market. As a result, this may revoke a member's role in the market.

A market can be divided into auctions that allow bidding to take place for the utility. To add an auction, an addAuction command may be supported that specifies a new market cycle, with start and end times. The auction may be opened on a specific market and include a specific auction ID. With respect to an auction, a setAuctionListing function may list a specified quantity of energy at a certain price that is available from the DSO. This may include information about available quantity, cost, or timestamp. The listing may be identified by a listing ID provisioned with the listing for a certain auction identified by the auction ID. An addBid function may allow qualified members to bid subject to membership specifications and qualifications. For example, a qualified member may be a member with a bidder membership to the specific market holding the auction. A bid may be identified by a bid ID and include a timestamp, desired quantity, associated auction identified by auction ID, member ID. Additionally, a bid may have a bid type, for example, a buy bid (consumer/demand) or a sell bid (producer/supply). An auction may be withdrawn through a withdrawAuction function that allows a market auctioneer to remove a market cycle before it ends or to ignore bids. The withdrawAuction function may identify an auction and include a result ID. The result ID may correspond to a specific auction and indicate the time the auction was created and the results of the auction, such as the result type (proper close, no bids, unknown, or withdrawn). The withdrawAuction function may trigger a closeAuction function. Once the market cycle ends, closeAuction may clear the market based on the bids. It may also trigger the creation of billing invoices. For example, the closed auction may include a result ID which can be used to specify the end result of the auction. Transactions can be determined based on bids held in the auction and an invoice event can be created. The invoice event may indicate the cleared bid associated with a member and the cost and quantity of the bid. Due to the modular nature of the TES, the security properties, such as access permissions, may be enforced by the lower levels, using access control lists and the identities (e.g., the user that initialized the request).

The blockchain-based TES may include a number of verifications to ensure proper execution of the market. For example, in one scenario, a market will eventually receive bids and process the clearing prices. In this example, a timing mismatch cause the auctioneer to incorrectly trigger an early market closure, but the application logic denies it based on the intended end time associated with the auction. A second, well-timed attempt may succeed to close the market. In another example, an auction is listed, but no bids are received. As a result, the auction may close with CLOSED_ERROR_NO_BIDS. Later, when the invoker misses the reply and attempts to reclose, the application (e.g., the smart contract) may gracefully handle the case and deny a second auction close. In a different example, an auction is listed but no bids are received, thus, the auction closes with CLOSED_ERROR_NO_BIDS. After the auction is closed, a malicious actor may try to reclose the market, but is prevented by the security policy. In yet another example, an auction is listed, but the auctioneer decides to withdraw it before it ends. In this example, the auction may close with WITHDRAWN_OK.

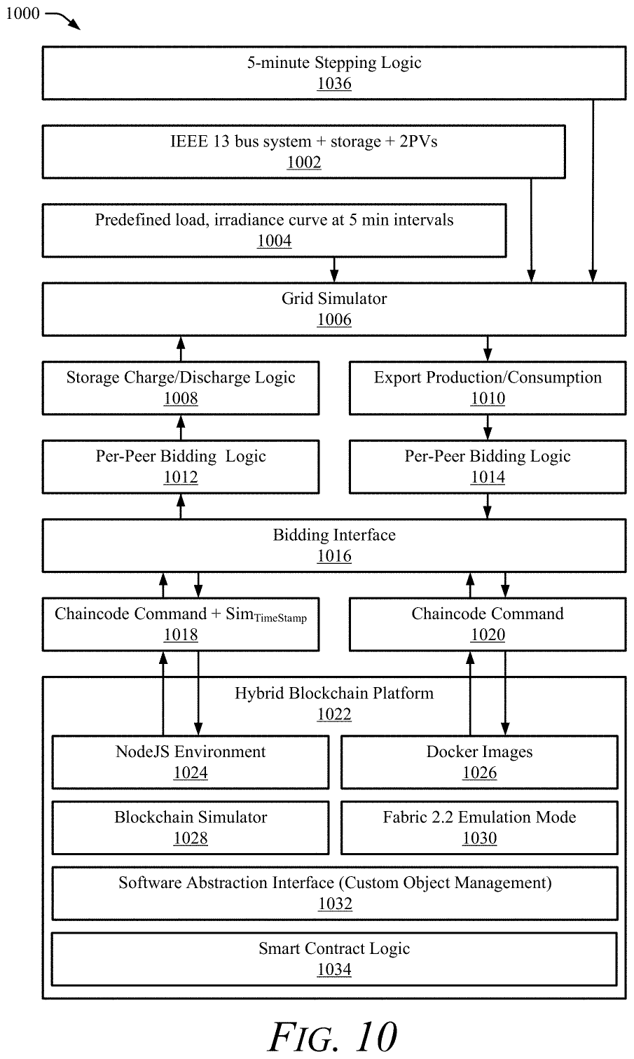

FIG. 10 illustrates an example communication architecture 1000 of market clearance in a double-auction blockchain-based transactive energy system. The chaincode script was implemented as a hybrid blockchain platform 1022 in Node.js and deployed over a Fabric 2.2 network (from the Hyperledger docker images 1026). Such a deployment allows researchers and potential users to test the TSSC capabilities, under realistic-world environments. This includes adding multiple peers (e.g., agents), incorporating multiple organizations, and evaluating multiple network architectures. To simplify this deployment, a middleware platform was developed. The platform allows code to seamlessly run on a native blockchain environment or to execute inside a single-threaded Node s Environment 1024 that emulates the behavior of a Fabric network running in a single-node setup.

When operating in Fabric 2.2 emulation mode 1030, a representational state transfer (REST) API may be exposed that allows clients to send commands and set variables, such as the peer identity and transaction time. This effectively masks nonidealities such as lost commands, commit order, and rollbacks while storing data in the same format as the real blockchain to act as a blockchain simulator 1028. Therefore, the program was first thoroughly evaluated in an emulator environment, and then certain configurations were tested inside the Hyperledger environment. When connected through the emulator interface, the actions are transmitted over a REST interface (e.g., software abstraction interface 1032), and the grid simulator 1006 sets the chaincode command 1020, system time stamp 1018 associated with the chaincode command, and identities. Moreover, the hybrid blockchain platform 1022 can facilitate interaction with the market through smart contract logic 1034 supported by the hybrid blockchain platform 1022. However, if a real blockchain interface is required, the commands may be manually inserted into each peer and are subject to the global system time that exists within a blockchain network.

Market operation logic is maintained in per-peer bidding logic 1012 and per-peer bidding logic 1014 that interacts through the bidding interface 1016. Export production and consumption 1010 is provided to the per-peer bidding logic 1014 from the grid simulator 1006 and bidding occurs over the bidding interface 1016 based on the data. This bidding interface facilitates data associated with the market operation to the per-peer bidding logic 1012, which is input to storage charge/discharge logic 1008 to affect the grid simulator 1006.

In a specific implementation, the chaincode was executed in a multi-peer, multi-organization Fabric network with the aim of evaluating the performance of the algorithm in a real consensus network. The grid is simulated using the Institute of Electrical and Electronics Engineers (IEEE) 13 bus system 1002 with storage and two photovoltaic (PV) systems. It should be noted, however, that any other bus system may be used. The simulation is subject to a global-time variable that is agreed upon by the distributed peers, and therefore, the client (e.g., the grid simulator 1006) may follow the system clock and emit the orders according to this time frame (e.g., 5-minute stepping logic 1036). Since the TSSC logic relies on specific time windows that dictate the operations' validity and order (e.g., opening, listing, bidding, and clearing), the grid simulator was provided a predefined load 1004 that includes irradiance curves at five-minute intervals.

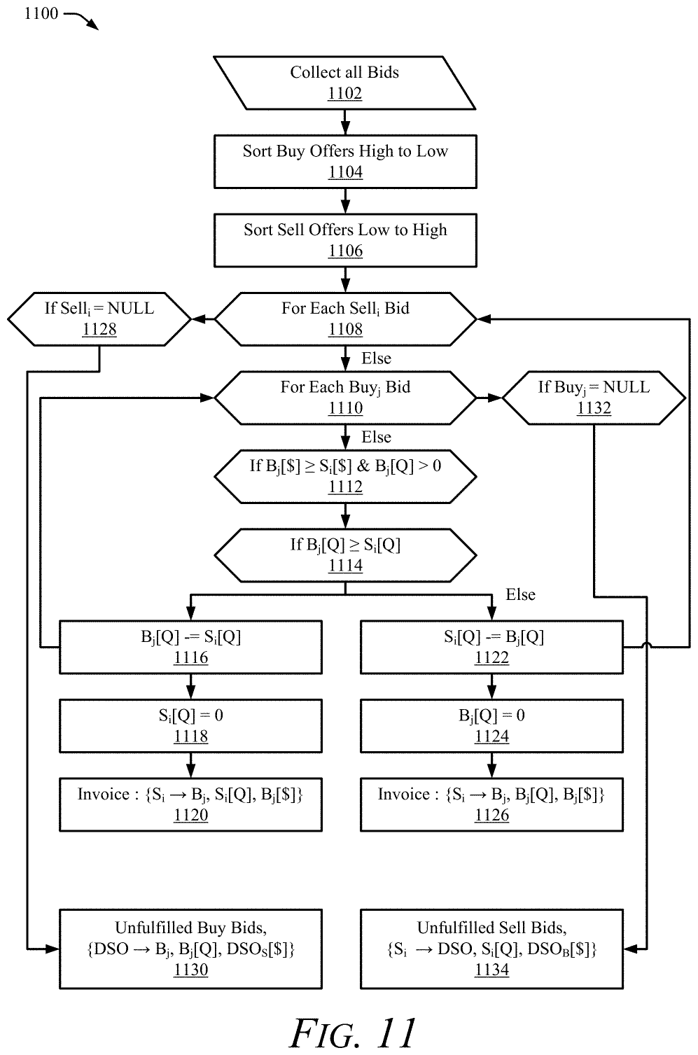

FIG. 11 illustrates an example flow chart 1100 of market clearance logic in a blockchain-based TES. In this flow chart 1100, sellers (S) that provide the cheapest energy get an earlier chance to fulfill a buy bid (B) as long as the buy bid is greater than or equal to the price of the seller. Any bids that remain unsatisfied are then satisfied (sold by/acquired) from the DSO. In this implementation, the DSO has its own pricing scheme that may be based on the price to store or generate energy to satisfy remaining bids. The scheme used here ignores any transaction fees, broker fees, or grid fees that may be associated with other grids.

For example, market-clearing begins by collecting all bids at 1102. To determine the order in which buy bids are satisfied, the buy bids are sorted from high to low at 1104 with highest priced buy bids satisfied first. The sell bids are then sorted low to high at 1106 to allow the lowest priced sell bids to be satisfied first. For each sell bid at 1108 is determined if a valid bid exists. If so, the next buy bid is taken at 1110 and, at operation 1112, if the buy bid has a price ($) higher than or equal to the sell bid, the buy bid is satisfied for the quantity (Q) bid (assuming the quantity is greater than zero). If the buy bid quantity is larger than the sell bid quantity at 1114, the buy bid quantity is reduced by the sell bid quantity at 1116, and the reduced buy bid is placed back in the buy bid queue at 1110. The sell bid quantity is then set to zero at 1118 (e.g., the bid is satisfied) and an invoice is made at 1120 for a sale from the seller to the buyer. The sale is invoiced with a quantity the same as the sell bid quantity with the buy bid price.

Alternatively, if the sell bid quantity is greater than the buy bid quantity, the sell bid quantity is reduced by the buy bid quantity at operation 1122, and the sell bid is placed back in the sell bid queue at 1108. The buy bid quantity is then set to zero at 1124 and an invoice is created at 1126 for a sale from the seller to the buyer. The sale will now be invoiced as the buy bid quantity at the buy bid price.

If the sell queue is ever empty at 1128 and buy bids remain, the DSO may fulfill (sell to the buyer) any unfulfilled buy bids at 1130. In this case, the sale will be invoiced as a sale from the DSO to the buyer for a utility quantity equal to the buy bid and at the pre-determined selling price of the DSO. Alternatively, if the buy bid queue is empty at 1132 and sell bids remain, the DSO may fulfill (buy from the seller) any unfulfilled sell bids at 1134. In this case, the sale will be invoiced as a sale from the seller to the DSO for a utility quantity equal to the sell bid quantity and at the pre-determined DSO buying price. It should be noted, however, that this market-clearing logic is a specific example of market clearing and any other logic may be used based on the desired market type.

While market clearing in a bidding market is shown in FIG. 11, the blockchain-based TES may be operated on a non-bidding market. In this example, the DSO may decide not to participate in the TES. To account for overproduced energy or overbid energy, the utility may offer an energy buyback program at a percentage of the going rate, for example, 80%. In a time-of-use pricing scheme, low-cost energy may be purchased at low-usage hours, while high-cost energy is for sale at peak hours. In this implementation, a smart controller may progressively buy energy during low-cost hours and seek to maximize the use of photovoltaic resources. To this effect, the smart controller may progressively sell energy during peak hours. As a result, the use of photovoltaic resources may be maximized. In a TES, a smart controller may bid for a consumer or producer under this scheme when the market is active.

### Example Method

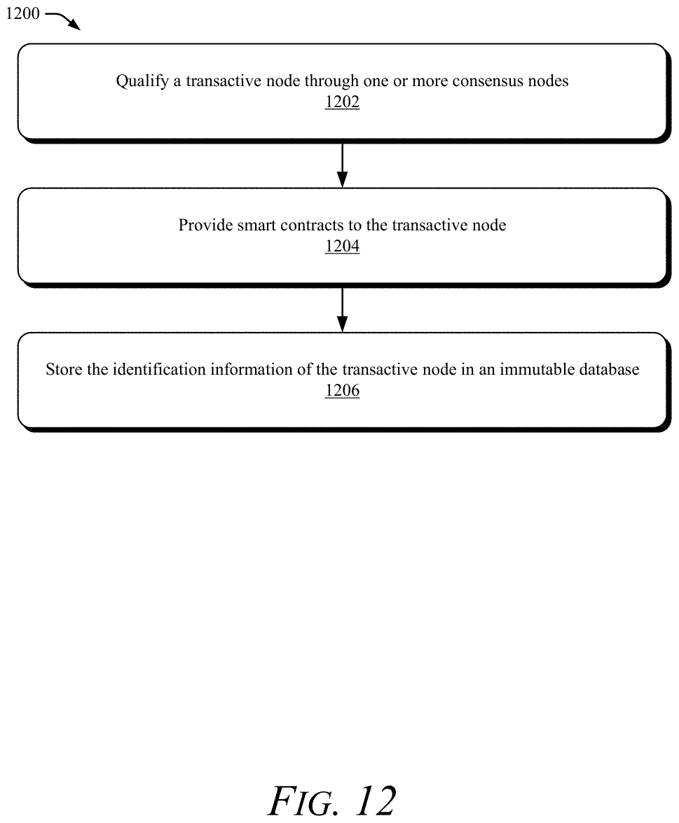

FIG. 12 illustrates an example method for node registration and qualification in a blockchain-based TES. The method 1200 is described, for clarity, with reference to the elements of FIG. 1. The operations 1202 through 1206 may be performed but are not necessarily limited to the order or combinations in which the operations are shown herein. Further, any of one or more of the operations may be repeated, combined, or reorganized to provide other operations.

At 1202, a transactive node 104 is qualified by one or more consensus nodes 110. In aspects, the transactive node 104 is a logical entity and is qualified based on predetermined parameters that the transactive node 104 must meet. For example, the transactive node 104 may be based on software requirements to execute the smart contracts 106 or security requirements to meet the security requirements of the integrated blockchain 112. This may include supporting certain cryptographic functions or compatibility requirements. Alternatively, or in addition, the one or more consensus nodes 110 may be associated with peers or market overseers. For example, the consensus nodes 110 may be associated with producers, consumers, or market operators that have registered as voting nodes in the TES. In other implementations, the consensus nodes 110 may be a separate third-party entity that is not directly associated with the TES. To register as a consensus node 110, an agent may be required to meet certain qualifications, as is required to register as a transactive node 104. These requirements may be identical to or different from the requirements to register as a transactive node 104.

As part of the qualification, the transactive node 104 may be provided with terms and conditions or registration questions to participate in the market. The transactive node 104 may be required to answer the questions or agree to the terms and conditions to participate in the market. For example, the qualification of the transactive node 104 may be based on the answers to the registration questions. The registration questions may also be used to gather identification information about the agent associated with the transactive node 104 to store in the immutable database 108. This information may help for verification, accountability, or identity creation during operation of the TES.

At 1204, smart contracts 106 are provided to the transactive node 104. The smart contracts 106 may be provided in response to qualifying the transactive node 104. Based on the transactive node 104, the smart contracts 106 may provide predetermined access in the TES. For example, the transactive node 104, consensus nodes 110, and market operator 114 may all be provisioned smart contracts 106 that provide varying access to the TES. Specifically, peers may be provided smart contracts 106 to allow them read-only access to the immutable database 108. Further, the transactive node 104 may be provisioned with smart contracts 106 such that the transactive node 104 only has access to see bids placed by itself. This may allow bids placed by peers to remain hidden and thus, keep the market safe from manipulation.

The smart contracts 106 may also facilitate interaction between the elements of the TES. For example, the smart contracts 106 may be used to supply a bid to an auction within the market. The smart contracts 106 may provide communications between the markets in a predetermined form to allow communications to be handled without an intermediary. For example, requests sent to the transactive node 104 may request data of a certain length and structure through the smart contracts 106. The transactive node 104 may respond through smart contracts 106 that manipulate the response into the desired form.

The smart contracts 106 may be integrated into the chosen blockchain 112. For example, blockchain technology supports the use of smart contracts 106 to facilitate operations between the immutable database 108 and other elements of the blockchain 112. Smart contracts 106 may facilitate block creation, read/write operations, and verification operations within the blockchain. In doing so, the TES may be operable without any physical intervention in the system. Further, smart contracts 106 may increase the security of the TES. By provisioning specific access to each node of the TES, a successful cyberattack on a single node may result in only the corruption and manipulation of a single node environment. Thus, the cyberattack may control the breach to only actions provisioned to the single node, as opposed to the attacker gaining access to the entire TES. As a result, the modular approach to the blockchain-based TES may provide additional security.

At 1206, identification information of the transactive node 104 is stored in the immutable database 108. The identification information may include information requested from the transactive node 104 at registration. This information may be used to identify the transactive node 104 or in identity creation during operation of the TES. By storing the identification information in the immutable database, the information may be referenced if needed for any TES operation. For example, the information may be used when auditing the TES, to create a UUID associated with a bid from the transactive node 104, or to add the transactive node 104 to markets or auctions.

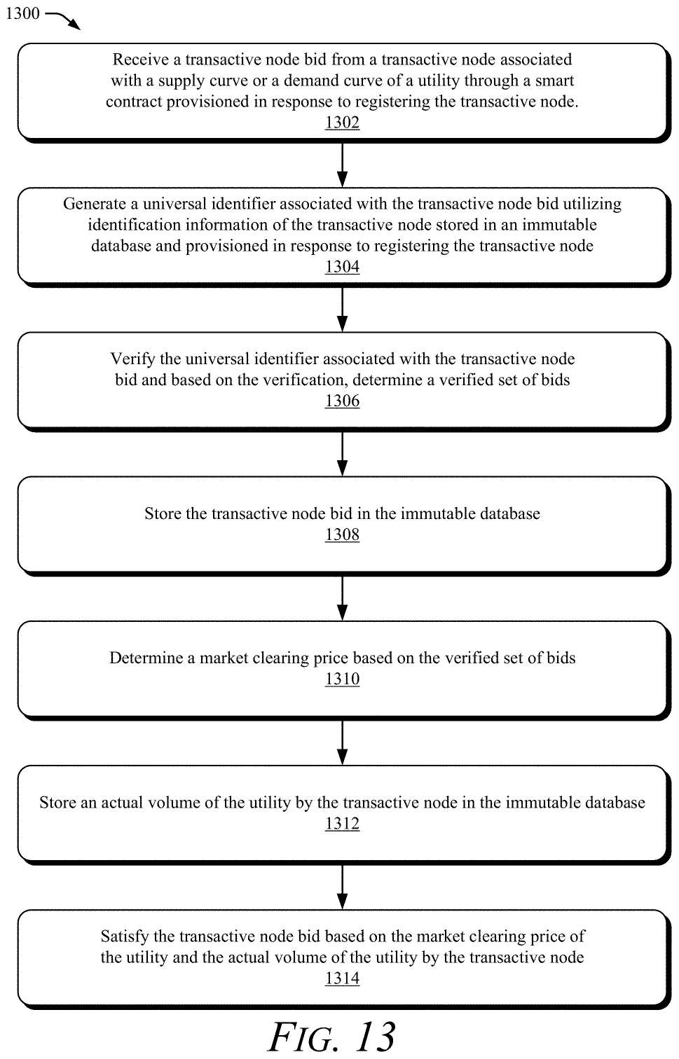

FIG. 13 illustrates an example method for implementing a blockchain-based TES. At 1302, a bid associated with at least one of a supply curve or a demand curve of a utility is received from a transactive node 104 and through smart contracts 106 provisioned in response to registering the transactive node 104. In some implementations, the smart contracts 106 are provisioned in response to registering the transactive node 104 through the at least one consensus node 110. The bid may be facilitated through the smart contracts 106 in a specific predetermined form. The bid may include one or more quantities and prices at which a consumer/producer quantity to buy/sell.

In aspects, an auction is opened by the market operator 114 or an auctioneer prior to receiving the bid from the transactive node 104. The auction may be opened with a specified start and end time where bids may be received. Bids may be associated with specific auctions, for example, a bid may include an auction ID that specifies the particular auction that it is intended for. Auctions may be opened by a set of logical operations that open an auction at a predetermined time interval, for example, an auction may be opened and closed every five minutes.

At 1304, a universal identifier is generated that is associated with the bid from the transactive node 104 and based on identification information of the transactive node stored in the immutable database 108 and provisioned in response to registering the transactive node 104. The universal identifier may be an R-UUID that is unique at each market cycle and unique for each individual. The universal identifier may be created through a cryptographic operation that hides the identity of the transactive node 104 or agent that enters a bid. For example, PKI may be used to provide an anonymous universal identifier that may be verified and stored in the immutable database 108. However, if necessary, cryptographic operations may be performed by qualified individuals to determine the identity of the bid-submitting transactive node 104. For example, an auditor may be able to determine the identity of the transactive node 104 through PKI.

In some implementations, the smart contracts 106 use the information collected at registration and qualification to determine the universal identifier. For example, this may include information provided by the agent in response to the registration questions or the terms and conditions. The universal identifier may further be based on a rotational seed to maintain entropy and uniqueness in the universal identifier. As a result, the universal identifier may provide increased cryptographic strength against market manipulation and cyberattacks.

At 1306, the universal identifier associated with the transactive node 104 bid is verified and based on the verification, a verified set of bids is determined. In some implementations, the universal identifier is verified by the one or more consensus nodes 110 through a voting process. Alternatively, or in addition, the universal identifier may be verified based on adherence to a required format or structure. If verified, the universal identifier may be added to a verified set of bids. In aspects, the verified set of bids is used in market clearing 130.

In some implementations, if the universal identifier is not verified, the auction may be paused until the universal identifier is verified. This may increase security and decrease the likelihood of a cyberattack reaching an active auction and affecting market clearing. This may include communications between the transactive node 104 and the consensus nodes 110 to determine the problem associated with the universal identifier. Alternatively, or in addition, failing to verify the universal identifier may result in a message being sent to the transactive node 104 that entered the bid associated with the universal identifier, a peer node, or the market operator 114. The failure to verify the universal identifier may be stored in the immutable database 1308 to use in future market operations or for verification purposes.

At 1308, the bid from the transactive node 104 is stored within the immutable database 1308. In aspects, the immutable database 1308 stores the bids of each market cycle to allow for future verification and auditing. The transactive node 104 bid may be stored in the immutable database 1308 to verify market-clearing or a final transaction associated with the bid. In some implementations, the bids are stored as blocks in the immutable database 108 using one or two methods. In the first method, blocks are created based on a set number of bids. Specifically, each block stored in the immutable database 108 includes a set number of bids. An advantage of this method is that each block may have the same size due to the same number of bids in each block. The second method creates a single block for all bids in a market cycle. In this implementation, all bids from a single market cycle may be stored in a same block, which may allow for easy verification and auditing in the future. It should be noted, however, that each market cycle is not required to contain the same number of bids so the size of each block may vary.

At 1310, a market-clearing price 134 is determined based on the verified set of bids. For example, the smart contracts 106 may contain market logic that settles the bids included in the verified set of bids to determine a market-clearing price 134. The market-clearing price 134 may be determined based on any number of market types. For example, FIG. 1 illustrates a double-auction market. Other markets that may be used include, but are not limited to, consensus and bilateral trade markets. Market clearing 130 may also include a determination of a cleared quantity 132. In aspects, the cleared quantity 132 corresponds to the quantity of a utility that has been cleared for sale in the market cycle at the market-clearing price 134.

In some implementation, the market-clearing price 134 or the cleared quantity 132 are verified by the one or more consensus nodes 110. In aspects, the market-clearing price 134 or the cleared quantity 132 are stored in the immutable database 108 for future verification and audits. Once market clearing 130 has ended, the market-clearing price 134 or the cleared quantity 132 may be published to members of the market cycle. For example, the market-clearing price 134 or the cleared quantity 132 may be published to the transactive node 104, the consensus nodes 110, or the market operator 114. Additionally, by storing the market-clearing price 134 or the cleared quantity 132 in the immutable database 108, nodes of the TES may reference the results of market clearing 130 at any time, thus increasing transparency in the market.

At 1312, an actual volume of the utility by the transactive node 104 is stored in the immutable database 108. The actual volume of the utility may correspond to a consumption or production of the utility by the transactive node 104. For example, a consumer may consume a quantity of the utility during the measured time while a producer may produce a certain quantity of the utility during the measured time. In some implementations, the actual volume of the utility is provided by the transactive node 104. In aspects, the actual volume of the utility may be provided without an intermediary, for example, through a smart meter that automatically records and provides the production or consumption of the utility by the transactive node 104 to the market operator 114 or the peer nodes. In some implementations, the peer nodes may provide the actual consumption or production of a utility by the transactive node 104 to maintain accountability in the market.

At 1314, the transactive node 104 bid is satisfied based on the market-clearing price 134 of the utility and the actual volume of the utility by the transactive node 104. For example, satisfying the transactive node 104 bid may include comparing the transactive node 104 bid with the actual volume (production/consumption) of the utility by the transactive node 104 and based on the comparison, billing the transactive node 104. Billing the transactive node may include providing the actual volume of the utility up to the bid amount at the market-clearing price. If the actual volume of utility is greater or less than the bid quantity, the billing may include billing the transactive node for the cost to store or generate the difference.

The billing may additionally include retrieving the transactive node 104 bid from the immutable database 108 and comparing it to the actual volume of the utility by the transactive node 104. The retrieved transactive node 104 bid from the immutable database 108 may be verified for integrity. For example, a hash or signature of the bid retrieved may be verified to ensure the validity of the bid retrieved from the immutable database 108. In some implementations, a consistency factor may be determined based on the comparison of the transactive node 104 bid received from the immutable database 108 and the actual volume of the utility by the transactive node 104. For example, a positive consistency factor may correspond to a small discrepancy between the transactive node 104 bid and actual volume of the utility by the transactive node 104. In contrast, a negative consistency factor may correspond to a large discrepancy.

In some implementations, incentives or penalties may be determined based on the consistency factor of the transactive node 104. For example, additional charges may be imposed if a transactive node has a negative consistency factor. In another example, charges may be reduced if a transactive node 104 has a positive consistency factor. The consistency factor may be stored in the immutable database 108 for future market operations. For example, if a transactive node 104 continues to receive negative consistency factors, a message may be sent to the transactive node 104 as a warning that market rules are not satisfied. In some implementations, a transactive node may be removed from the market or the TES as a whole, based on a negative consistency factor.

Once the billing is resolved, a transaction may be conducted between the transactive node and the correct entity for payment. In a peer-to-peer system, transactions may take place directly between transactive node 104 that consumed and a peer node that supplied the utility. In a peer-to-utility system, transactions may take place between the transactive node 104 that consumed the utility and the market operator 114. In this implementation, the market operator 114 may distribute the appropriate payment to the peer node (e.g., producer transactive node) that supplied the utility. The transaction may include acknowledgment of the payment by the transactive node 104 or the market operator 114 to the immutable database 108. In aspects, this provides a traceable record of payment for future audits. In some implementations, the transaction may be verified by the one or more consensus nodes 110 before the transaction clears. In response to verifying the transaction, the consensus information or the transaction may be stored in the immutable database 108. At the end of a market cycle, a block may be created that provides a record of the market cycle for each node. In doing so, the blockchain-based TES may provide a decentralized, secure, and verifiable market for the trade of a utility.

### EXAMPLES

Examples of blockchain-based TESs are provided below:

Example 1: A computer-implemented method for implementing a blockchain-based transactive energy system, the method comprising: receiving, from a transactive node, a transactive node bid associated with at least one of a supply curve of a utility or a demand curve of a utility, the bid facilitated through a smart contract provisioned in response to at least one consensus node registering the transactive node; generating a universal identifier associated with the transactive node bid utilizing identification information of the transactive node stored in an immutable database provided by a blockchain, the identification information provisioned in response to registering the transactive node; verifying, by at least one consensus node, the universal identifier associated with the transactive node bid; determining a verified set of bids in response to verifying the universal identifier associated with the transactive node bid; storing the transactive node bid in the immutable database; determining, based on the verified set of bids, a market-clearing price of the utility; storing, in the immutable database, an actual volume of the utility by the transactive node, the actual volume comprising an actual production of the utility by the transactive node or an actual consumption of the utility by the transactive node; and satisfying the transactive node bid based on the market-clearing price of the utility and the actual volume of the utility by the transactive node.

Example 2: The method as recited by Example 1, further comprising: registering the transactive node before receiving the transactive node bid, the registering comprising: qualifying, by the consensus node, the transactive node; providing the smart contract to the transactive node, wherein the smart contract further comprises logical operations that provide the transactive node with a predetermined access to the blockchain-based transactive energy system; and storing, in the immutable database, the identification information of the transactive node.

Example 3: The method as recited by Example 1, further comprising: opening, by a market operator node, an auction of the blockchain-based transactive energy system before receiving the transactive node bid; and wherein the transactive node bid is associated with the auction.

Example 4: The method as recited by Example 3, wherein the opening the auction is performed utilizing a set of logical operations configured to open the auction at a predefined time interval.

Example 5: The method as recited by Example 1, further comprising: responsive to failing to verify the universal identifier associated with the transactive node bid, delaying the determination of the market-clearing price of the utility until the universal identifier associated with the transactive node bid has been verified.

Example 6: The method as recited by Example 1, wherein satisfying the transactive node bid based on the market-clearing price of the utility and the actual volume of the utility by the transactive node further comprises: at least one of: comparing the transactive node bid with the actual production of the utility by the transactive node; or comparing the transactive node bid with the actual consumption of the utility by the transactive node; and billing the transactive node based on the comparison and the market-clearing price.

Example 7: The method as recited by Example 6, wherein billing the transactive node further comprises: retrieving the transactive node bid from the immutable database; comparing the transactive node bid retrieved from the immutable database with the actual volume of the utility by the transactive node; and determining a consistency factor for the transactive node based on the comparison of the transactive node bid retrieved from the immutable database with the actual volume of the utility by the transactive node.

Example 8: The method as recited by Example 7, wherein billing the transactive node further comprises: verifying the transactive node bid retrieved from the immutable database based on a signature or hash of the bid retrieved from the immutable database.

Example 9: The method as recited by Example 7, wherein billing the transactive node further comprises at least one of: incentivizing the transactive node based on the consistency factor; or penalizing the transactive node based on the consistency factor.

Example 10: The method as recited by Example 6, wherein satisfying the transactive node bid based on the market-clearing price of the utility and the actual volume of the utility by the transactive node further comprises: verifying, by the one or more consensus nodes, a transaction of the transactive node representative of the billing the transactive node; and responsive to verifying the transaction of the transactive node, storing the transaction of the transactive node in the immutable database.

Example 11: The method as recited by Example 1, wherein the actual volume of the utility by the transactive node is based on at least one of: a representation of the actual production of the utility by the transactive node determined by a smart meter associated with the transactive node; or a representation of the actual consumption of the utility by the transactive node determined by a smart meter associated with the transactive node.

Example 12: The method as recited by Example 1, further comprising, storing the market-clearing price in the immutable database after determining a market-clearing price.

Example 13: The method as recited by Example 1, wherein the consensus node corresponds to at least one of a producer of the utility or a consumer of the utility.

Example 14: The method as recited by Example 1, wherein the transactive node corresponds to a producer of the utility or a consumer of the utility.

Example 15: The method as recited by Example 1, wherein the market-clearing price is determined based on a double-auction market.

Example 16: A blockchain-based transactive energy system comprising: a transactive node; a consensus node; a processor; and a computer-readable storage media having stored thereon instructions that, responsive to execution by the processor, cause the processor to perform operations comprising: receive, from the transactive node, a transactive node bid associated with at least one of a supply curve of a utility or a demand curve of a utility, the bid facilitated through a smart contract provisioned in response to the consensus node registering the transactive node; generate a universal identifier associated with the transactive node bid utilizing identification information of the transactive node stored in an immutable database provided by a blockchain, the identification information provisioned in response to registering the transactive node; verify, by the consensus node, the universal identifier associated with the transactive node bid; responsive to verifying the universal identifier associated with the transactive node bid, determine a verified set of bids; store the transactive node bid in the immutable database; determine, based on the verified set of bids, a market-clearing price of the utility; store, in the immutable database, an actual volume of the utility by the transactive node, the actual volume comprising an actual production of the utility by the transactive node or an actual consumption of the utility by the transactive node; and satisfy the transactive node bid based on the market-clearing price of the utility and the actual volume of the utility by the transactive node.

Example 17: The blockchain-based transactive energy system as recited by Example 16, further comprising: a remote server communicatively coupled to the transactive node and the consensus node.

Example 18: The blockchain-based transactive energy system of example 16, wherein the processor is further configured to register the transactive node before receiving the transactive node bid by performing further operations comprising: receive, from the consensus node, a qualification of the transactive node; provide the smart contract to the transactive node, the smart contract further comprising logical operations that provide the transactive node with a predetermined access to the blockchain-based transactive energy system; and store, in the immutable database, the identification information of the transactive node.

Example 19: The blockchain-based transactive energy system of example 16, further comprising a market operator node, wherein the processor is further configured to: open, by the market operator node, an auction of the blockchain-based transactive energy system before receiving the transactive node bid, wherein the transactive node bid is associated with the auction.

Example 20: The blockchain-based transactive energy system of example 16, wherein the transactive node is a logical entity that meets specific criteria to participate in the blockchain-based transactive energy system.

### CONCLUSION

While various embodiments of the disclosure are described in the foregoing description and shown in the drawings, it is to be understood that this disclosure is not limited thereto but may be variously embodied to practice within the scope of the following claims. From the foregoing description, it will be apparent that various changes may be made without departing from the spirit and scope of the disclosure as defined by the following claims. Although described as a blockchain-based TES, blockchain may be useful for market execution of any number of utilities, for example, water, gas, wireless internet, and the like. Therefore, the blockchain-based TESs described herein are described with respect to a specific utility only for simplicity, and this description does not limit the applicability of blockchain-based TESs to other utility markets. Moreover, the framework described is agnostic to a specific blockchain and thus, should not be limited to the specific implementation described above. Specifically, the blockchain-based TES can be applied on any blockchain, market, or utility grid.

The use of “or” and grammatically related terms indicates non-exclusive alternatives without limitation unless the context clearly dictates otherwise. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

What is claimed is:

1. A computer-implemented method for implementing a blockchain-based transactive energy system, the method comprising:
receiving, from a transactive node, a transactive node bid associated with at least one of a supply curve of a utility or a demand curve of a utility, the bid facilitated through a smart contract provisioned in response to at least one consensus node registering the transactive node;
generating a universal identifier associated with the transactive node bid utilizing identification information of the transactive node stored in an immutable database provided by a blockchain, the identification information provisioned in response to registering the transactive node;
verifying, by at least one consensus node, the universal identifier associated with the transactive node bid;
determining a verified set of bids in response to verifying the universal identifier associated with the transactive node bid;
storing the transactive node bid in the immutable database;
determining, based on the verified set of bids, a market-clearing price of the utility;
storing, in the immutable database, an actual volume of the utility by the transactive node, the actual volume comprising an actual production of the utility by the transactive node or an actual consumption of the utility by the transactive node; and
satisfying the transactive node bid based on the market-clearing price of the utility and the actual volume of the utility by the transactive node.

2. The method of claim 1, further comprising:
registering the transactive node before receiving the transactive node bid, the registering comprising:
qualifying, by the consensus node, the transactive node;
providing the smart contract to the transactive node, wherein the smart contract further comprises logical operations that provide the transactive node with a predetermined access to the blockchain-based transactive energy system; and
storing, in the immutable database, the identification information of the transactive node.

3. The method of claim 1, further comprising:
opening, by a market operator node, an auction of the blockchain-based transactive energy system before receiving the transactive node bid; and
wherein the transactive node bid is associated with the auction.

4. The method of claim 3, wherein the opening the auction is performed utilizing a set of logical operations configured to open the auction at a predefined time interval.

5. The method of claim 1, further comprising:
responsive to failing to verify the universal identifier associated with the transactive node bid, delaying the determination of the market-clearing price of the utility until the universal identifier associated with the transactive node bid has been verified.

6. The method of claim 1,
wherein satisfying the transactive node bid based on the market-clearing price of the utility and the actual volume of the utility by the transactive node further comprises:
at least one of:
comparing the transactive node bid with the actual production of the utility by the transactive node; or
comparing the transactive node bid with the actual consumption of the utility by the transactive node; and
billing the transactive node based on the comparison and the market-clearing price.

7. The method of claim 6, wherein billing the transactive node further comprises:
retrieving the transactive node bid from the immutable database;
comparing the transactive node bid retrieved from the immutable database with the actual volume of the utility by the transactive node; and
determining a consistency factor for the transactive node based on the comparison of the transactive node bid retrieved from the immutable database with the actual volume of the utility by the transactive node.

8. The method of claim 7, wherein billing the transactive node further comprises:
verifying the transactive node bid retrieved from the immutable database based on a signature or hash of the bid retrieved from the immutable database.

9. The method of claim 7, wherein billing the transactive node further comprises at least one of:
incentivizing the transactive node based on the consistency factor; or
penalizing the transactive node based on the consistency factor.

10. The method of claim 6, wherein satisfying the transactive node bid based on the market-clearing price of the utility and the actual volume of the utility by the transactive node further comprises:
verifying, by the one or more consensus nodes, a transaction of the transactive node representative of the billing the transactive node; and
responsive to verifying the transaction of the transactive node, storing the transaction of the transactive node in the immutable database.

11. The method of claim 1, wherein the actual volume of the utility by the transactive node is based on at least one of:
a representation of the actual production of the utility by the transactive node determined by a smart meter associated with the transactive node; or
a representation of the actual consumption of the utility by the transactive node determined by a smart meter associated with the transactive node.

12. The method of claim 1, further comprising, storing the market-clearing price in the immutable database after determining a market-clearing price.

13. The method of claim 1, wherein the consensus node corresponds to at least one of a producer of the utility or a consumer of the utility.

14. The method of claim 1, wherein the transactive node corresponds to a producer of the utility or a consumer of the utility.

15. The method of claim 1, wherein the market-clearing price is determined based on a double-auction market.

16. A blockchain-based transactive energy system comprising:
a transactive node;
a consensus node;
a processor; and
a computer-readable storage media having stored thereon instructions that, responsive to execution by the processor, cause the processor to perform operations comprising:
receive, from the transactive node, a transactive node bid associated with at least one of a supply curve of a utility or a demand curve of a utility, the bid facilitated through a smart contract provisioned in response to the consensus node registering the transactive node;
generate a universal identifier associated with the transactive node bid utilizing identification information of the transactive node stored in an immutable database provided by a blockchain, the identification information provisioned in response to registering the transactive node;
verify, by the consensus node, the universal identifier associated with the transactive node bid;
responsive to verifying the universal identifier associated with the transactive node bid, determine a verified set of bids;
store the transactive node bid in the immutable database;
determine, based on the verified set of bids, a market-clearing price of the utility;
store, in the immutable database, an actual volume of the utility by the transactive node, the actual volume comprising an actual production of the utility by the transactive node or an actual consumption of the utility by the transactive node; and
satisfy the transactive node bid based on the market-clearing price of the utility and the actual volume of the utility by the transactive node.

17. The blockchain-based transactive energy system of claim 16, further comprising:
a remote server communicatively coupled to the transactive node and the consensus node.

18. The blockchain-based transactive energy system of claim 16, wherein the processor is further configured to register the transactive node before receiving the transactive node bid by performing further operations comprising:
receive, from the consensus node, a qualification of the transactive node;
provide the smart contract to the transactive node, the smart contract further comprising logical operations that provide the transactive node with a predetermined access to the blockchain-based transactive energy system; and
store, in the immutable database, the identification information of the transactive node.

19. The blockchain-based transactive energy system of claim 16, further comprising a market operator node, wherein the processor is further configured to:
open, by the market operator node, an auction of the blockchain-based transactive energy system before receiving the transactive node bid,
wherein the transactive node bid is associated with the auction.

20. The blockchain-based transactive energy system of claim 16, wherein the transactive node is a logical entity that meets specific criteria to participate in the blockchain-based transactive energy system.
